(19) United States
(12) Patent Application Publication
(10) Pub. No.: US 2012/0049455 A1
(43) Pub. Date: Mar. 1, 2012

(54) Gaming Table

(76) Inventors: Justin Jin Han YAP, Singapore (SG); Benny LUI, Penang (MY)

(21) Appl. No.: 12/869,169

(22) Filed: Aug. 26, 2010

(51) Int. Cl. A63F 3/00; A63F 13/00; A63F 9/24

(52) U.S. Cl. 273/274; 463/25; 463/30; 463/43

(57) ABSTRACT

Aspects of this disclosure relate to a gaming table which may include a surface upon which elements of a particular casino game may be placed and a player device configured to provide one or more services to a player at the gaming table. The player device may include a processor, a display, a means for providing input to the player device and memory storing computer executable instructions that, when executed, cause the player device to perform a method for providing one or more services to the player at the gaming table. Further, the player device may be configured to receive an input from the player at the gaming table, transmit data to a remote computer based on the input received from the player at the gaming table, and electronically receive data regarding the input from the player at the gaming table, wherein the electronically received data is based on the data transmitted to the remote computer.

### FIELD OF DISCLOSURE

Aspects of the present disclosure relate generally to gaming tables for use in casinos or simulated casinos. Particular aspects of the present disclosure relate to gaming tables which include an electronic data processing device configured to provide one or more services to a player at the gaming table.

### BACKGROUND

Gaming tables are used in casinos or other venues in order to provide a surface on which a game (e.g., a game of chance on which wagers can be made) may be played. Gaming tables are a point of contact and communication between a player and an organization operating the gaming table (e.g., a casino). This point of contact may be utilized to provide or enhance one or more services to both the player at the gaming table and, also, the organization operating the gaming table. Therefore, it would be advantageous to have a gaming table which is configured to provide or enhance such services to the player and the organization.

### SUMMARY

Therefore, aspects of this disclosure relate to a gaming table which includes one or more devices that are configured provide or enhance one or more services to both a player at the gaming table and, also, the organization. For example, aspects of this disclosure relate to a gaming table which may include a surface upon which elements of a particular casino game may be placed and a player device configured to provide one or more services to a player at the gaming table. The player device may include a processor, a display, a means for providing input to the player device and memory storing computer executable instructions that, when executed, cause the player device to perform a method for providing one or more services to the player at the gaming table. Further, the player device may be configured to receive an input from the player at the gaming table, transmit data to a remote computer based on the input received from the player at the gaming table, and electronically receive data regarding the input from the player at the gaming table, wherein the electronically received data is based on the data ,transmitted to the remote computer. According to aspects of the disclosure, the input from the player at the gaming table may be a request for funds, and the electronically received, data regarding the input from the player at the gaming table may be an approval or a denial of the request for funds from player at the gaming table.

Further aspects of the disclosure may relate to a computer assisted method for providing services to a player at a gaming table which may include electronically receiving data from a player device at the gaming table relating to a request for funds for the player operating the player device, electronically receiving data from a computer relating to a financial account associated with the player operating the player device, using a computer to assist in approving or denying the request for funds by making a series of determinations about the electronically received data and electronically transmitting an approval or denial of the request for funds to the player device and a dealer device at the gaming table. According to aspects of the disclosure, the determinations may include determining if the data related to the financial account associated with the player operating the player device indicates that a credit balance of the financial account is greater than the amount of funds requested by the player operating the player device.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a diagram of a general-purpose digital computing environment in which certain aspects of the present disclosure may be implemented;

FIG. 2 illustrates a block diagram of a computing environment in which certain aspects of the present disclosure may be implemented;

FIG. 3 is an illustrative embodiment of a player device according to one aspect of the disclosure;

FIG. 4a illustrates a conventional gaming table;

FIG. 4b illustrates a gaming table according to one or more illustrative aspects of the disclosure;

FIG. 5 is a flow chart illustrating a computer assisted method for providing services to a player at a gaming table according to aspects of the disclosure;

FIGS. 6a, 7a, 8a, 9a, 10a, 11a, 12a, 13a, 14a and 15a illustrate conventional gaming tables; and

FIGS. 6b, 7b, 8b, 9b, 10b, 11b, 12b, 13b, 14b and 15b illustrate gaming tables according to one or more illustrative aspects of the disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

Initially, it is noted that throughout the disclosure, the term casino may be used interchangeably with organization, business, etc. The term casino is not intended to be limiting, but rather merely describe a potential embodiment of the disclosure. Similarly, throughout the disclosure, the term player may be used interchangeably with person, guest, customer, etc. The term player is not intended to be limiting, but rather merely describe a potential embodiment of the disclosure.

As described above, gaming tables are a medium that provides a point of contact and communication between a player and an organization operating the gaming table (e.g., a casino). Therefore, aspects of this disclosure are directed to systems and methods for utilizing the gaming table to provide services for both the player and the organization operating the gaming table.

Gaming tables are used in games including, but not limited to: Baccarat, Black Jack, Poker (e.g., 3, 4, 5 or 7 card poker, open close poker, Russian poker, Texas Hold'em, Caribbean Stud poker, Show hand poker, and other types of poker games), Casino War, Majong, Craps, Fan Tan, Red and White balls, Pai Gow, Pontoon, Roulette, Sic Bo, money wheels, various types of games played with dice and generally all types of games of chance played in casinos and other gaming venues, such as betting salons, poker rooms, etc. Gaming tables, such as those described above, provide a unique opportunity to provide services to both the player and the casino. Potential services that may be provided may include entertainment, wagering and/or betting services that meet objectives of the casino, the individual player, or both.

For example, an objective for many casinos is to provide the player with a high level of customer service in order to ensure the customer is content with the casino. If the player is not satisfied with the level of service at the casino, then the player may choose to leave the current casino and play at a competing casino. This situation would likely decrease the casino's profitability. Therefore, the casino would prefer to keep a customer satisfied. Providing a high level of customer service to the player at the gaming table may include attending to the player's requests or needs while the player is at the gaming table. Further, providing a high level of customer service to the player at the gaming table may include attending to the player's requests or needs as quickly as possible.

Another objective for many casinos is to encourage the player to play the games at the casino for a large portion of the time during which the player is in the casino. In other words, many casinos may desire to reduce the amount of time a player spends away from the gaming tables during his or her stays at the casino. By increasing the amount of time a player spends at a gaming table, a casino is able to increase gaming volume and activities at the gaming table and, hence, likely increase the casino's profitability. Another objective for many casinos is to track and/or monitor players and detect fraud or cheating by players at a gaming table. Another objective for many casinos is to track and/or monitor players (e.g., through a Player Tracking System, or PTS) and use such information in order to provide players with complimentary services or merchandise (i.e., “comps”) or other rewards for their actions (e.g., the players' play at the gaming table). Another objective for many casinos is to provide dealers with support and assistance in their responsibilities as a dealer (e.g., providing dealers with support for quickly and reliably determining a player's payout for a winning wager, such as by providing a computer to perform calculations (e.g., computer assisted calculations) at a gaming table). Another objective for many casinos is to provide dealers with support and assistance to allow the dealers to provide improved customer service to the player while at a gaming table (e.g., providing a dealer with player profile information (e.g., through a computer) which can allow the dealer to enhance a player's experience at the gaming table).

Additionally, it is noted that an individual player may also have objectives. For example, a player at a gaming table may wish to be able to import and/or view score charts or other reference material related to one or more games (e.g., charts of recent gaming history, probability charts, etc.), or create personal charts or personal notes related to the game, wagers, etc. Such charts or personal notes may assist the player is playing the game, making wagers, etc.

Further, a player at a gaming table may wish to perform calculations (e.g., computer assisted calculations) at a gaming table. For example, a player at a gaming table may wish to ensure that a payout of a winning wager is correct without having to rely on the player's own or dealer's mental arithmetic. Also, a player at a gaming table may wish to perform calculations related to their own personal winnings or losses.

Further, a player at a gaming table may wish to communicate with the casino. For example, the player may wish to request funds without having to leave the gaming table. Also, the player may wish to place bets on multiple gaming tables without leaving the gaming table.

Further, a player at a gaming table may wish to perform errands without leaving the gaming table. For example, a player may wish to make or extend a reservation, make or modify travel arrangements, transfer funds from a bank or other financial institution, etc. without leaving the gaming table.

The above described objectives are merely examples of objectives faced by casinos and customers and, of course, a casino or player may have other objectives, such as those that will be discussed in further detail below. There are no conventional gaming tables which are configured to provide services which can meet player and casino objectives, such as those described above and others. Therefore, aspects of the disclosure relate to utilizing a gaming table to provide services which can meet such objectives faced by casinos and players.

For example, aspects of the disclosure relate to a system and method which utilizing gaming tables to provide services which can meet objectives faced by casinos and players. For example, the system and method according to aspects of the disclosure may include utilizing gaming tables to: provide and improve customer service for a player at a gaming table, provide lines of communication between the player and the casino, provide the ability to track a player and/or monitor a player's play at a gaming table.

Further, a system and method according to aspects of the disclosure may include utilizing gaming tables to: provide the player with the ability to import and/or view charts or other reference material related to one or more games or create personal charts or personal notes related to the game, wagers, etc., provide the player with ability to perform computer assisted calculations at a gaming table, provide the player with ability to request funds from the casino without having to leave the gaming table, provide the player with ability to place bets on multiple gaming tables without leaving the gaming table, and provide the player with ability to perform errands without leaving the gaming table.

For example, according to aspects of the disclosure, a gaming table may include one or more devices. For example, such device(s) may be generally engaged with (e.g., embedded or placed onto) a gaming table. Further, according to aspects of the disclosure, the device may be positioned so as to correspond to players' seating positions or the dealer's position. In this way, a player or dealer may easily access and operate the device in order to perform various services, such as those described above.

According to aspects of the disclosure, the device(s) may be an element of a system and configured to communicate with other elements of the system. For example, according to aspects of the disclosure, the device(s) may be configured to communicate with elements, such as a central computer (e.g., a central computer operated by casino), a computer operated by a dealer at the gaming table, or a computer operated by a pit manager. Further, according to aspects of the disclosure, the device(s) may be configured to communicate with other networks, such as the Internet. Aspects of the disclosure will be described in detail below.

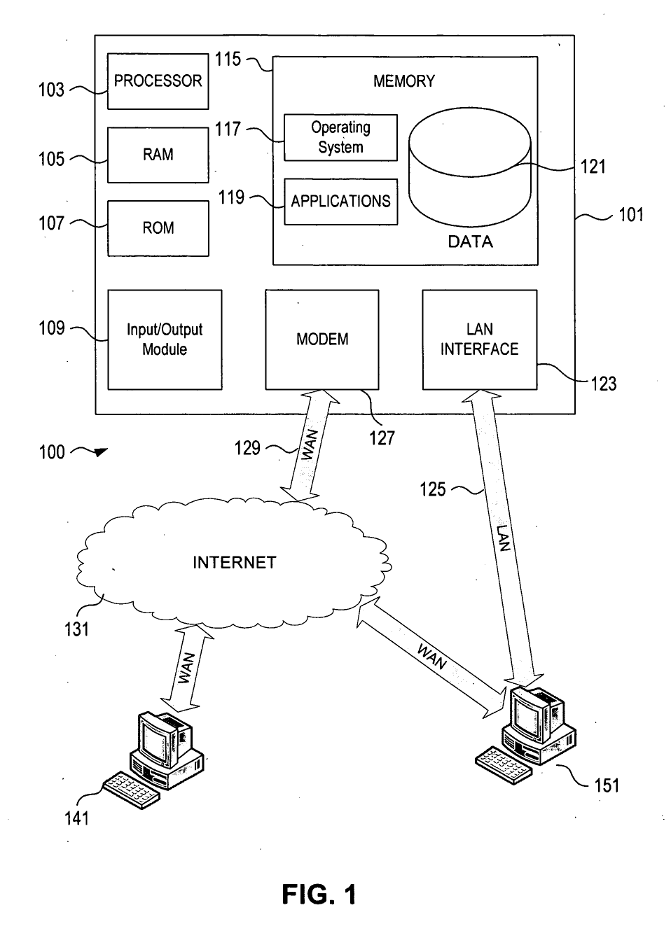

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

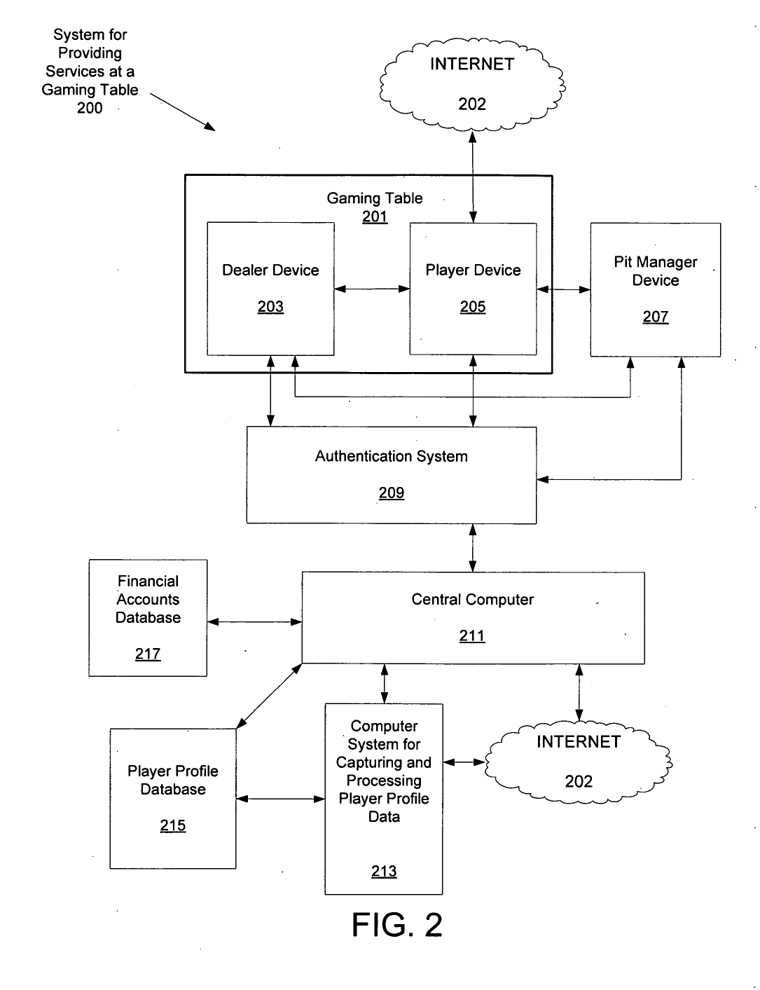

FIG. 2 is a diagram which shows an illustrative system 200 for providing services at a gaming table according to one or more illustrative aspects of this disclosure. As seen in FIG. 2, according to aspects of the disclosure, the system 200 may include: a gaming table 201, one or more dealer devices 203, one or more player devices 205, one or more pit manager devices 207, an authentication system 209, a central computer 211 (e.g., a central computer operated by the casino), a computer system for capturing and processing customer profile data 213, a customer profile database 215 and a financial accounts database 217. Further, as seen in FIG. 2, various elements of the system 200 may transmit data to and receive data from an outside network, such as the Internet 202 (other internal and/or external networks may also be used). Additionally, according to aspects of the disclosure, the system 200 may include a PTS which monitors a player's play at the gaming table and throughout the casino in order to provide the player with “comps” or other rewards. According to aspects of the disclosure, the PTS may be part of the system 200 (e.g., part of one of the elements of the system 200, such as central computer 211, the computer system for capturing and processing customer profile data 213, or the customer profile database 215 or, alternatively, a separate element in the system 200) or a separate system with which the system 200 communicates. It is noted that while only one gaming table, dealer device, player device and pit manager device is shown, more than one of the each of the items may be included in the system.

Further, as seen in FIG. 2, according to aspects of the disclosure, the gaming table 201 may include one or more dealer devices 203 and one or more player devices 205 (for example, one device for each player and/or dealer position at the table). According to aspects of this disclosure, the one or more player devices 205 may transmit data to and receive data from a dealer device 203. Further, according to aspects of this disclosure, the one or more player devices 205 may transmit data to and receive data from the pit manager device 207. It is noted that according to aspects of the disclosure, a player device 205 may transmit data to, and receive data from, another player device 205. (however, cheating may be discouraged or restricted). Additionally, according to aspects of this disclosure, the one or more player devices 205 may transmit data to and receive data from an outside network, such as the Internet 202.

Also, according to aspects of this disclosure, the one or more player devices 205 may transmit data to, and receive data from, the central computer 211. For example, a player may have to authenticate their identity in order to use a player device 205. Therefore, as seen in FIG. 2, the system 200 may include an authentication system 209. The authentication system 209 may transmit data to, and receive data from, the central computer 211 (e.g., a central computer operated by the casino). Of course, if desired, the one or more player devices 205 may transmit data directly to and receive directly data from the central computer 211.

Similarly, the one or more dealer devices 203 may transmit data to and receive data from the player devices 205, the pit manager device 207, the authentication device 209 and the central computer 211. Further, as mentioned above, if desired, the one or more dealer devices 203 may transmit data directly to and receive directly data from the central computer 211. Further, the one or more pit manager devices 207 may transmit data to and receive data from the player's devices 205, the dealer devices 207, the authentication device 209 and the central computer 211. Further, as mentioned above, if desired, the one or more pit manager devices 207 may transmit data directly to and receive directly data from the central computer 211.

According to aspects of the disclosure, the central computer 211 may transmit data to and receive data from each of the one or more dealer devices 203, the one or more player devices, the one or more pit manager devices 207, the computer system for capturing and storing customer profile data 213, the customer profile database 215 and the financial accounts database 217. Further, according to aspects of this disclosure, the central computer 211 may transmit data to and receive data from an outside network, such as the Internet 202.

The above described system 200 represented in FIG. 2 will be described in more detail below. However, it is noted here that one or more of the elements in the above described system 200 (e.g., the dealer device 203, the player devices 205, the pit manager device. 207, the authentication system 209) may include a computer system with a processor and a memory.

According to some aspects of this disclosure, a casino may have a preexisting relationship with the player at a gaming table. For example, the player may be a hotel guest of the casino, or may belong to a loyalty program of the casino. Hence, the customer may have provided information, such as the player's name, address, telephone number, email address, age, etc. upon booking a reservation with the hotel or while checking into the casino. According to aspects of the disclosure, such information may be captured and transmitted to one or more databases which store such information. For example, according to aspects of this disclosure, a casino may have one or more computer systems 213 for capturing and processing such data so that it is configured into a profile associated with the player (e.g., a player profile). The computer systems 213 used for capturing and processing player profile data, may be configured to allow players to input such player profile data (e.g., via a web based system prior to casino visit) or allow casino employees to enter such customer profile data (e.g., during check in). Further, the computer systems 213 may be configured to transmit such data to one or more databases for storing the player profile data. For example, if the player or casino employee enters such player profile data, then the player profile data may be transmitted to and stored in a customer profile database 215 associated with the computer systems 213 used for capturing and processing player profile data. Also, the computer systems 213 used for capturing and processing player profile data may be configured to transmit the player profile data to other computer systems or databases within the casino. Therefore, according to aspects of the disclosure, the player profile data may be retrieved from the customer profile database 215 and transmitted to various elements in the system 200.

According to aspects of the disclosure, the player may create one or more financial accounts with the casino. For example, the player may create a financial account with the casino which allows the player to use such funds for gambling or other purposes (e.g., shows, restaurants, bars, etc.) at the casino. The player may make deposits, withdrawals, balance transfers, etc. from the financial account. According to aspects of the disclosure, information about the player's financial accounts associated with the casino may be stored in a financial accounts database 217.

As described above, according to aspects of the disclosure, a system 200 may include a player device 205. According to aspects of the disclosure, the player device 205 may include a processor and a memory. Further, the player device 205 may be configured to transmit dka to, and receive data from, various elements of the system 200 and, also, networks outside the system 200. Additionally, as will be described in detail below, the player device 205 may be configured as desired to provide various services for the player.

According to aspects of the disclosure, the player device 205 may include a video display (e.g., a LCD screen or the like), a means for inputting data into the player device 205 (e.g., a keyboard or other buttons, a touch screen, a means for moving a cursor, voice recognition device, or the like), and a means for transmitting data to, and receiving data from, other devices or networks (e.g., computers in a network to which the player device 205 is attached or the Internet), such as wireless technology (e.g., Wi-Fi, Infrared, Bluetooth, Radio Frequency, etc.), hard wired technology, modems, DSL, etc. According to aspects of the disclosure, the player device 205 may include an audio system, including speakers for emitting audible sounds.

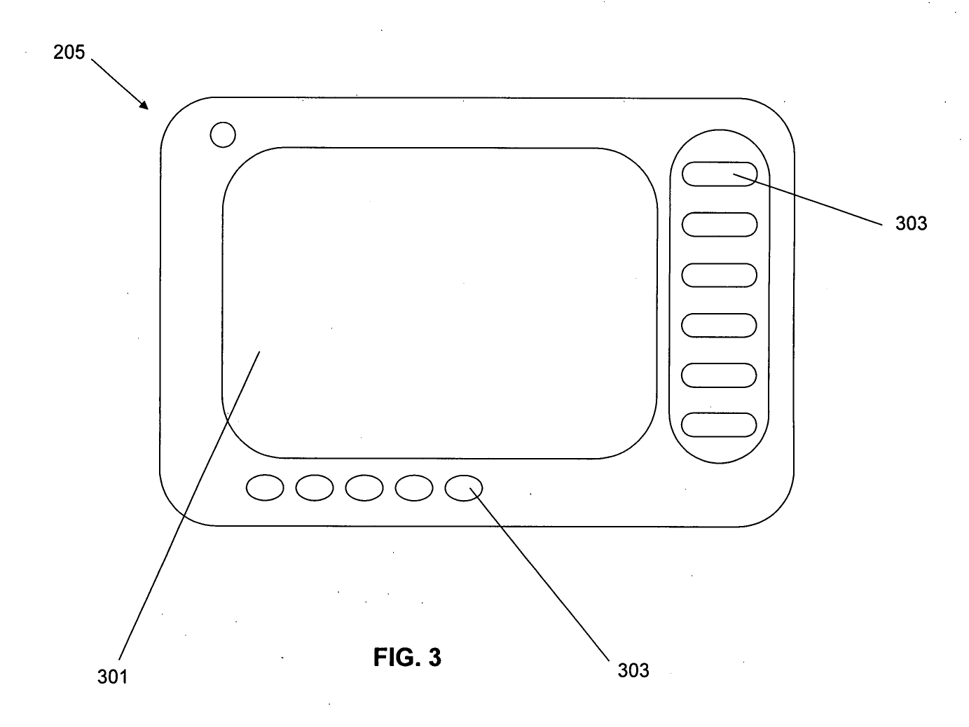

FIG. 3 is an illustrative embodiment of one such player device 205. As seen in FIG. 3, the player device 205 includes a display 301 (e.g., a touchscreen or non-touchscreen display) and one or more means 303 (e.g., buttons, toggles, directional pads, soft buttons for use with the touchscreen, etc.) for inputting data into the player device 205. It is noted, that the illustrative embodiment shown in FIG. 3 is merely an example, and other embodiments may be used as well. For example, the size and shape of the player device 205 may vary as desired. It is noted that the dealer device 203 and the pit manager device 207 may have similar constructions and features.

According to aspects of the disclosure, a player device 205 may be engaged with a gaming table 201. According to aspects of the disclosure, a player device 205 may be removably engaged or integrally engaged with the gaming table 201. For example, a player device 205 may be built into the gaming table 201 or the player device 205 may be relatively removable (e.g., attached via relatively permanent fasteners such as screws, bolts, etc.). According to aspects of the disclosure, the player device 205 may be attached on the top of the gaming table 201. Further, according to aspects of the disclosure, the player device 205 may be embedded or sunken into the gaming table 201 such that none of the player device 205 or only a portion of the player device 205 protrudes from the surface of the gaming table 201. According to aspects of the disclosure, a player device may be engaged with the gaming table 201 such that a player at the gaming table 201 can easily access and use the player device 205.

According to aspects of the disclosure, when the player device 205 is engaged with gaming table 201, the player device 205 may be hardwired or otherwise electronically connected to other elements of a network, such that the player device 205 may transmit data to, and receive data, from other elements in the network. For example, the player device 205 may be hardwired or otherwise electronically connected to one or more servers, the central computer 211, dealer devices 203, pit manager devices 207, other player devices 205, etc. Alternatively, as described above, the player device 205 may be configured to transmit data to, and receive data, from other elements in the network and other networks (e.g., the Internet) via any form of wireless technology, including Wi-Fi, Infra-Red, Bluetooth and Radio Frequency, etc. It is noted that the dealer device 203 and the pit manager device 207 may have similar constructions and features.

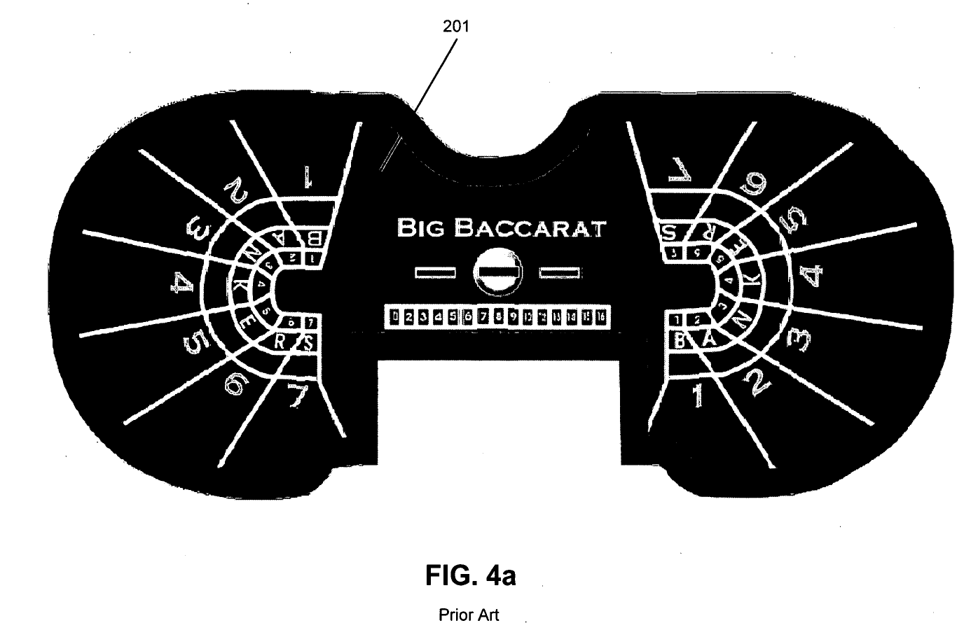

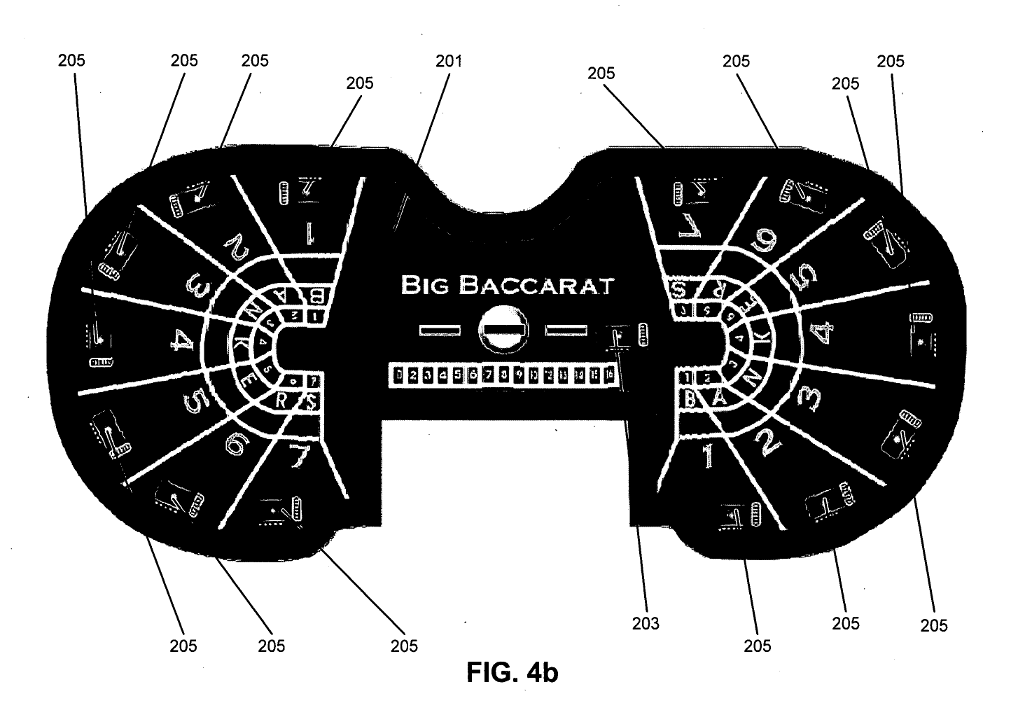

According to aspects of the disclosure, multiple player devices 205 may be engaged with a gaming table 201. For example, FIG. 4A is an illustrative embodiment of a conventional gaming table for Baccarat. As seen in FIG. 4A, the illustrative gaming table 201 has positions for 14 players to play simultaneously. According aspects of the disclosure, the number of player devices 205 engaged with the gaming table 201 may be equal to the number of positions for players that a particular gaming table 201 is configured to have. For example, in the Baccarat gaming table 201 described above, which has 14 positions for players, a gaming table 201 according to aspects of the disclosure may have 14 player devices 205 engaged with the gaming table 201. Further, according to aspects of the disclosure, the player devices 205 may be engaged with the gaming table 201 at the respective player positions. For example, FIG. 4B is an illustrative embodiment of a gaming table 201 according to aspects of the disclosure, wherein the gaming table includes a player device 205 positioned at each of the player positions, wherein the player playing at a respective position can easily access and use the player device 205.

Initially, it is noted that according to aspects of the disclosure, in order for a player to access and use a player device 205, the player may have to log in or otherwise authenticate themselves through the player device 205. This may be done in a variety of ways. For example, according to aspects of the disclosure, the player device 205 may be configured with a card reader and the player may swipe a card associated with the player in order to authenticate herself. For example, the card may be a magnetically coded card or other type of smart card. For example, if the player is a hotel guest of the casino, the player may have been issued a card upon checking into the casino, wherein the card has been configured to store customer profile data (e.g., the player's name, address, telephone number, email address, age, etc.). The player may run the card through the card reader of the player device 205 or press the card against the card reader of the player device 205 in order to authenticate herself and be able to utilize the player device 205. It is noted that the card may be the hotel room key if desired. Further, it is noted that the card may be a PTS card related to a PTS through which the player may earn points, credit, “comps” or other rewards, etc. Of course, the player device 205 may be configured to read the card without the card having to contact the card with a card reader. For example, the player device 205 may be configured to read the card if the card is held in a close proximity to the player device. For example, such contactless methods may use wireless technology, including but not limited to, Infrared, Radio Frequency, etc. as is known in the art.

Other types of authentication techniques that may be used include a player entering a name and a password into the player device 205. For example, the player device may be configured with a keypad and the player may manually type the name and password. Additional methods of authentication may include the player device 205 being configured with a scanner (e.g., a barcode scanner). Further, the player's card may include a barcode or other means of conveying information which is readable through the scanner. Alternatively, the barcode or other means of conveying information may be presented on a device with a display such as a smart phone, etc. For example, the casino may send the barcode or other means of conveying information to the player's smart phone via electronic mail, SMS, etc. Hence, the barcode or other means of conveying information may be displayed on the screen of the smart phone when the screen of the smart phone is held up to the scanner and the scanner may read the barcode or other means of conveying information in order to authenticate the player. Of course, other methods of authentication may be used as well. For example, another authentication method may include a portable USB drive, or the like, which contains player information such as described above. According to aspects of the disclosure, the player device 205 may be configured to receive a portable USB drive, or the like, and upload the player information contained thereon.

Further, according to aspects of this disclosure, biometrics may be used to authenticate a player. For example, biometric authenticating devices, such as retinal scanners, fingerprint scanners, facial recognition cameras, voice authentication audio systems, etc. may be employed in player device 205 in order to authenticate the player. It is noted that the dealer device 203 and the pit manager device 207 may employ similar techniques for authentication. For example, the dealers or pit managers may enter a name and a password into the dealer device 203 or pit manager device 207 (or use any other of the above described methods) in order to log in or otherwise authenticate themselves through the dealer device 203 or pit manager device 207.

Regardless of which method of authentication is desired, once the player device 205, the dealer device 203 or pit manager device 207 has received the authentication information, it may be transmitted to the authentication system 209. Further, the authentication system 209 may determine if the authentication information is valid and corresponds to the player, dealer or pit manager. For example, the authentication system 209 may retrieve information from the customer profile database 215 or the central computer 211 to determine if the submitted authentication information is valid and corresponds to the player, dealer or pit manager. Regardless of how the authentication system 209 verifies that the submitted authentication information is valid and corresponds to the player, dealer or pit manager, once the verification and authentication process has been completed, the player device 205, the dealer device 203 or pit manager device 207 may be configured to be used by the player, dealer or pit manager. For example, the central computer 211 may receive information from the authentication system 209 that the submitted authentication information is valid and corresponds to the player, dealer or pit manager and, hence, unlock the player device 205, the dealer device 203 or pit manager device 207 for the player's, dealer's or pit manager's use. According to aspects of the disclosure, configuring the one or more player devices 205 may include registering the player with a PTS and configuring the player device 205 to transmit data to, and receive data from, the PTS. In this way, information regarding the player's experience at the gaming table (e.g., money won or lost, number of rounds played, amount of time played, type of game played, etc.) may be transmitted to the PTS, which may then utilize such data to provide the player with points, “comps” or other rewards.

Additionally, if desired, some features of the player device 205 may be accessible and useable without logging in, while other features of the player device 205 may require a player to log in in order to access and use them. For example, generic features of the player device 205, such as downloading or importing score charts or using a calculator function (such features will be discussed in detail below) may be accessible without authentication, while other personalized features, such as accessing a financial account through the player device 205 may be accessible only upon being authenticated. Further, it is noted that, of course, if desired, no authentication system 209 is required and, instead, the system 200 may operate without an authentication system.

According to aspects, of the disclosure, the player device 205 may be configured based on predetermined settings the player has already arranged and stored in an account associated with the player (e.g., the player profile). For example, in previous sessions with the player device 205, the player may be have configured the player device 205 to provide various services (such as will be described below) or have various features arranged in the screen in a way that is familiar and comfortable for the player to use. As these customizable settings are particular to the individual player and stored in the player's account, such configurations and settings are available to the user whenever the player logs into a player device 205, regardless of which player device 205 the player uses.

As mentioned above, according to aspects of the disclosure, the player device 205, the dealer device 203 or pit manager device 207 may be configured to provide a multitude of services to the player and the casino. Examples of such services will be described in detail below.

According to aspects of the disclosure, the player device 205 may be configured to provide the player with access to one or more financial accounts (e.g., a financial account the player has arranged with the casino, such as the financial accounts described above). For example, according to aspects of the disclosure, the player's request to access their account may be communicated to the central computer 211. For example, the player may type or use voice commands to make the request. The central computer 211 may access the financial accounts database 217 and retrieve the financial account information. The financial account information may be transmitted from the central computer 211 to the player device 205 so that the financial account information may be displayed on the player device 205.

According to aspects of the disclosure, the player may use the player device 205 to request an amount of money be withdrawn from the player's financial account and provided to the player in chips at the gaming table. Again, the player may type or use voice commands to make the request. According to aspects of the disclosure, the player's request may be transmitted to the pit manager device 207 and, if desired, the dealer device 203. According to aspects of the disclosure, when the request for funds is sent to the pit manager device 207 (and, if desired, the dealer device 203), information regarding the player's financial account may be automatically generated and forwarded to the pit manager device 207 (and, if desired, the dealer device 203) along with the request for funds. According to aspects of the disclosure, the automatically generated information regarding the player's financial account may include the player's credit balance.

The pit manager may examine the request for funds and the automatically generated information regarding the player's financial account, such as the player's credit balance in order to determine if the request is viable based on the financial account information. For example, the pit manager may determine if the financial account associated with the player has a credit balance large enough to cover the requested amount. If the credit balance is large enough to cover the requested amount, the pit manager may approve such a request for funds. It is noted that according to other aspects of the disclosure, the information regarding the player's financial account with the casino may not be automatically forwarded to the pit manager device 207 with the request for funds. In such cases, the pit manager device 207 is configured to access the financial accounts database 217 or the central computer 211 and retrieve relevant information in order to make a determination.

According to aspects of the disclosure, the pit manager device 207 may be configured to access the player profile database 215 to determine if the player profile associated with the player has information which would be relevant to the player's request. For example, if the player profile indicates that the player is a VIP, a “high roller”, etc. then the pit boss may decide to provide the player with some degree latitude for the player's requests. For example, even if the player does not have a credit balance to cover the requested funds, if the customer is a VIP, a “high roller”, etc. then the pit boss may still honor the request. Hence, the pit manager device 207 is configured to allow the pit manager to approve or deny a request from the player. Alternatively, the casino computer system may automatically make a determination of whether to honor the request, based on rules and heuristics similar to those as would be decided in a manual context.

If the request for funds if honored, then the request for funds is processed by the central computer 211 and information regarding the approval and disbursement of funds is stored. For example, the amount of funds provided to the player may be stored either at the central computer 211 and/or in the financial account database 217. Further, it is noted that according to aspects of the disclosure, the pit manager may note a rationale for an approval or disapproval in the pit manager device 203 and, further, such approval may be forward to the central computer 211 (or an associated database) for storage.

According to aspects of the disclosure, the approval or disapproval of the player's request for funds may be communicated from the pit manager device 207 to the player device 205 and to the dealer device 203 and the dealer may then take appropriate action (e.g., provide a requested amount of chips if approved). According to aspects of the disclosure, if the player's request for funds is approved, then the dealer may process the transaction and provide the player with the requested amount of chips. It is noted that in order to process the transaction, the dealer device 203 may be configured to allow the dealer to transmit information to the central computer 211 verifying that the player received the correct amount of chips corresponding to the approved amount. According to aspects of the disclosure, the confirmation of the disbursement may also be communicated to the pit manager's device 203.

Hence, it is understood that aspects of the disclosure increase the efficiency with which a casino may attend to a player's requests for chips, a marker, an extension of credit, etc. For example, according to aspects of the disclosure such as described above, using elements of the above system 200, a pit manager to immediately attend to a player's requests.

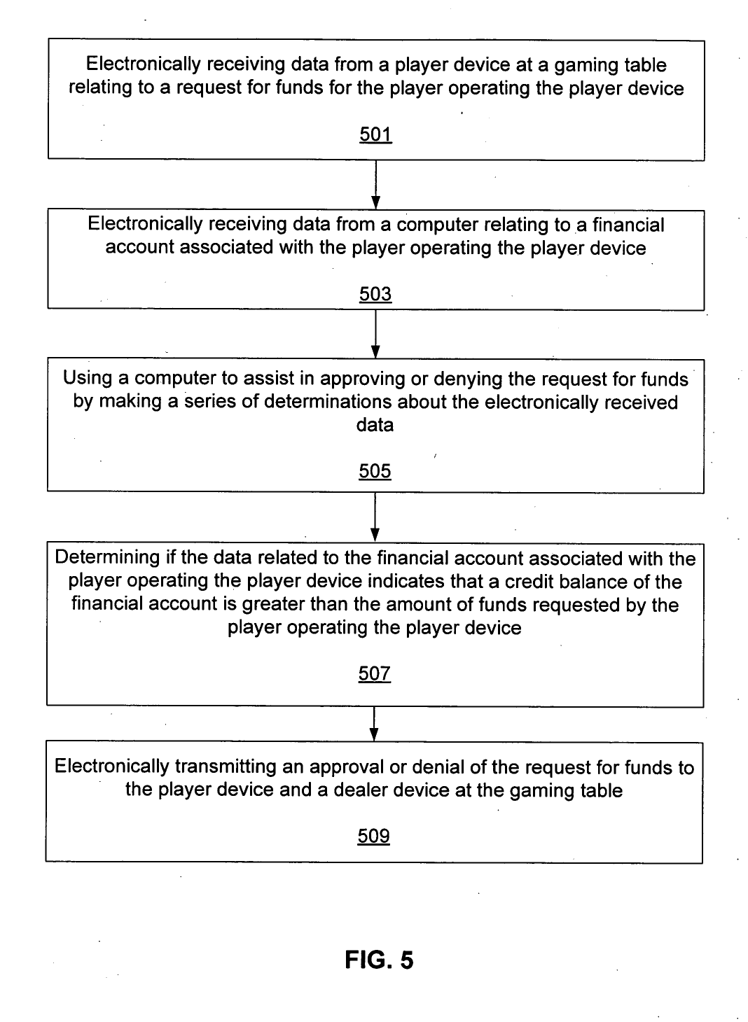

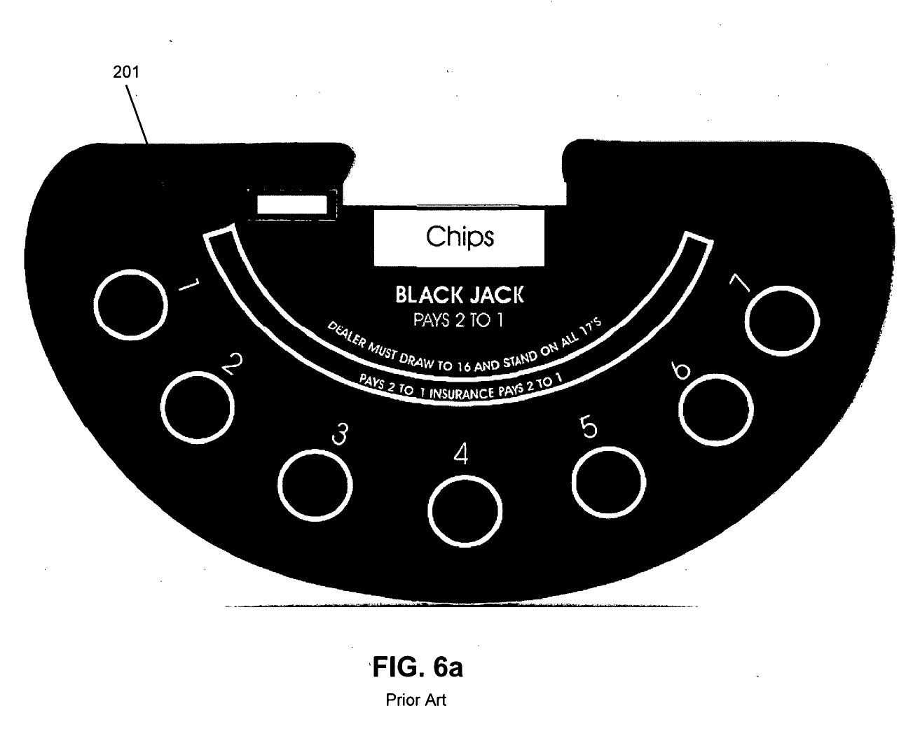

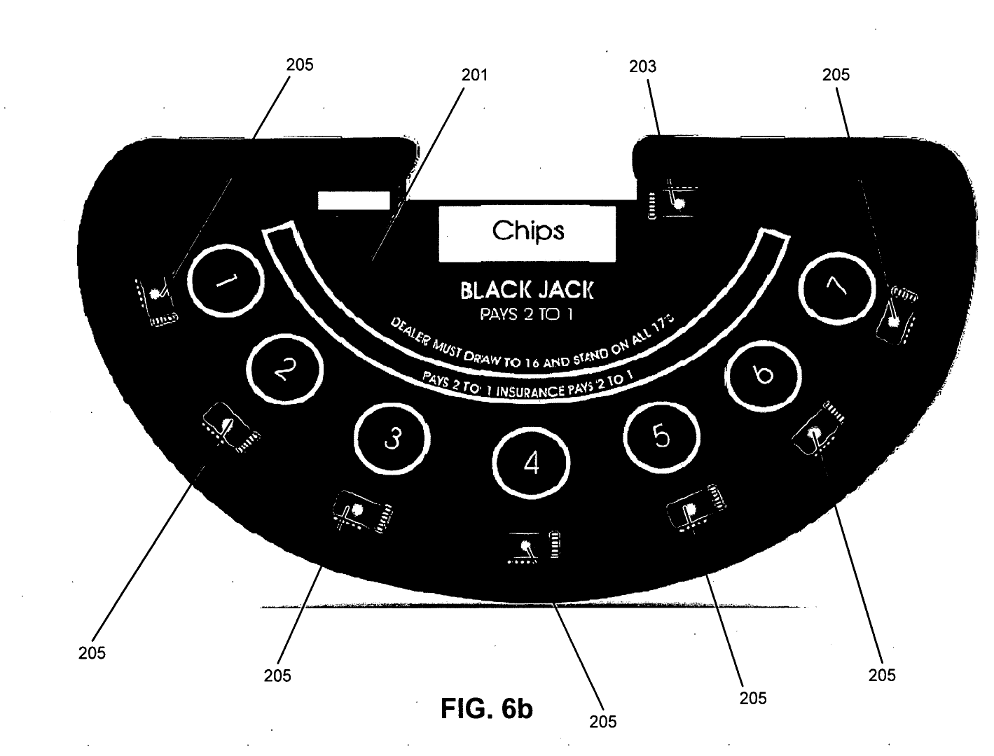

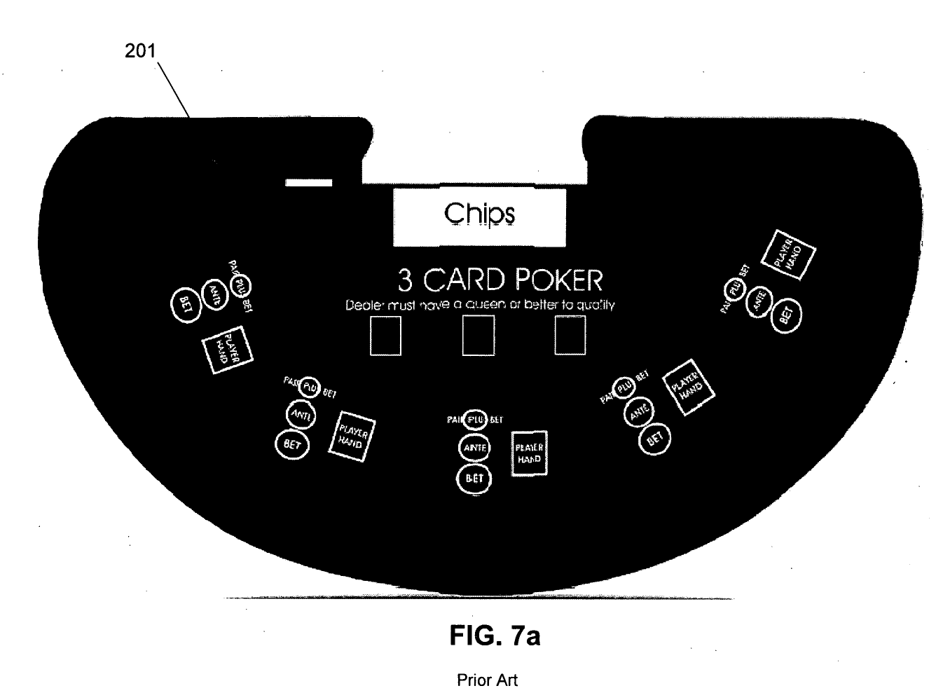

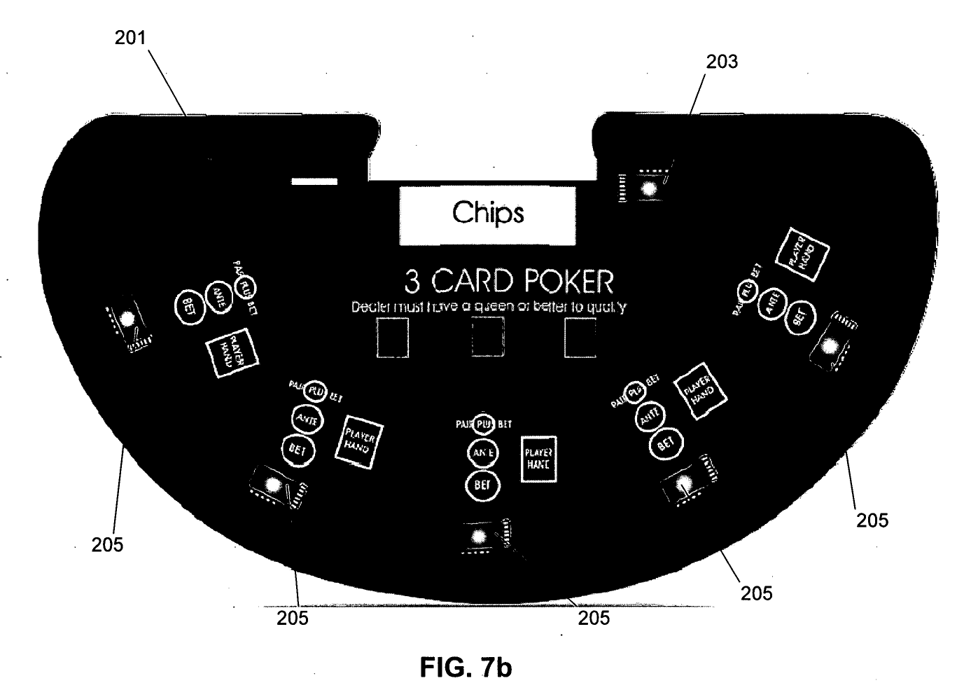

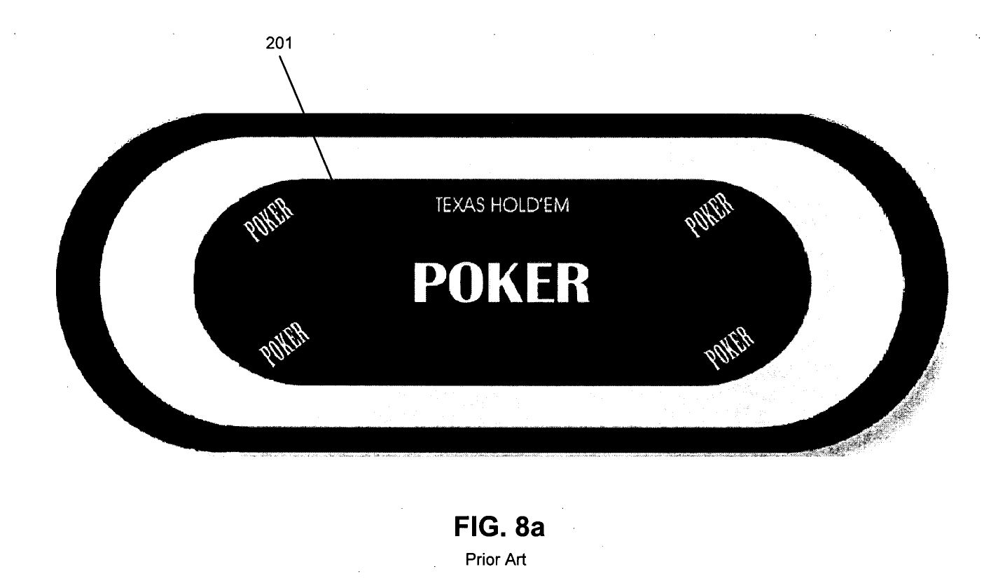

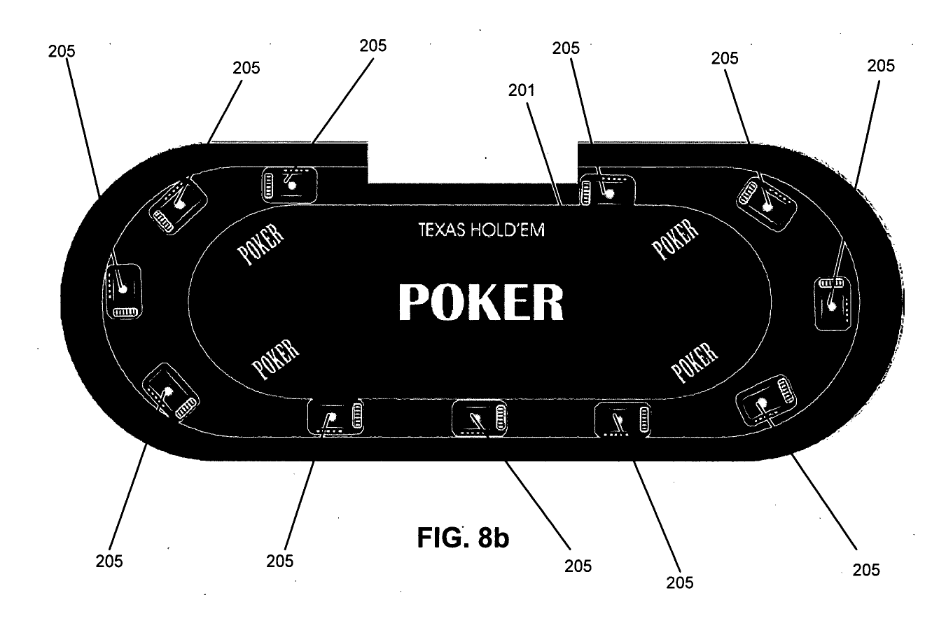

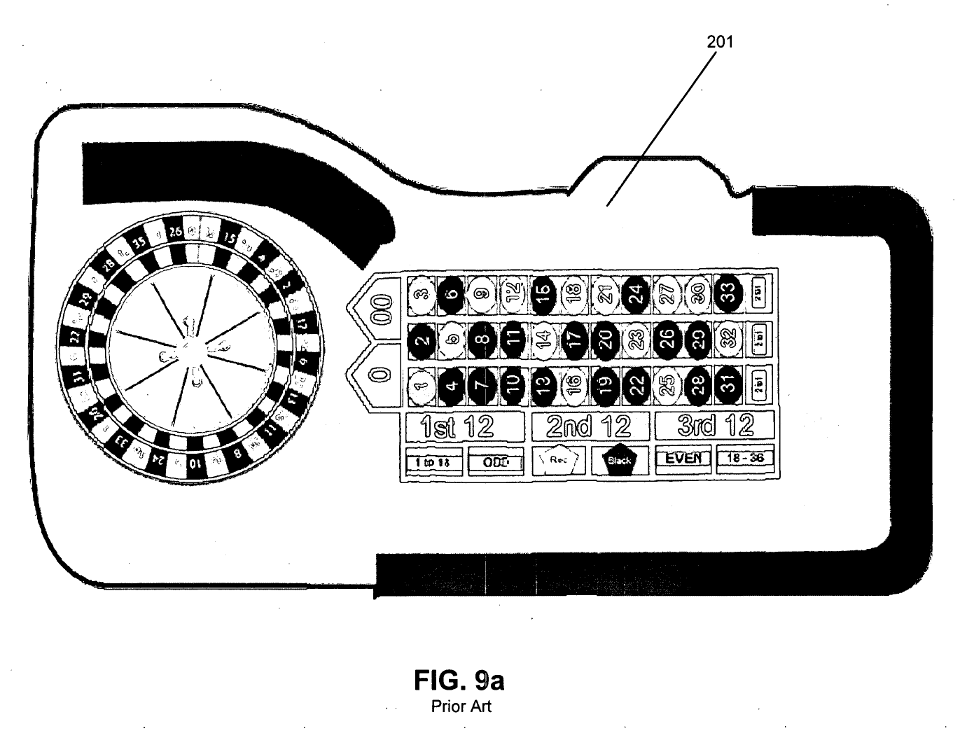

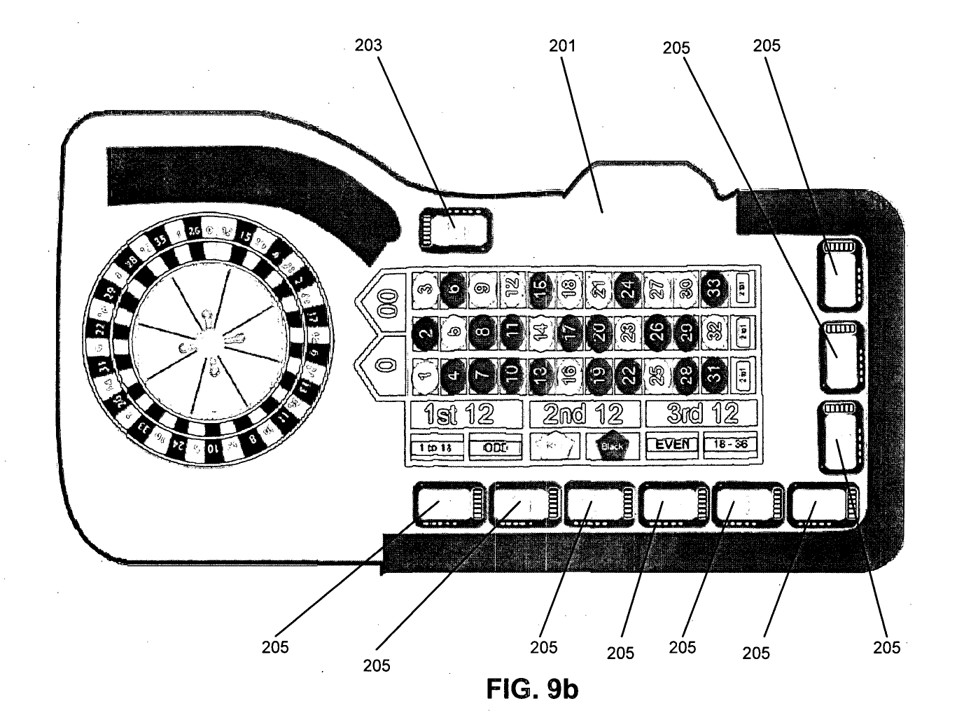

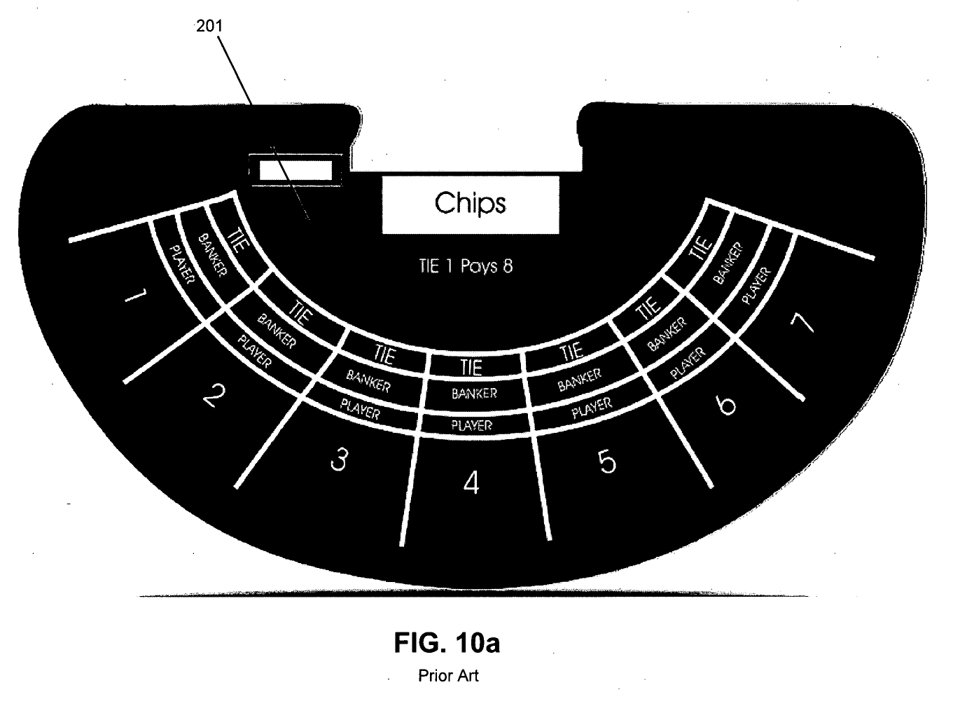

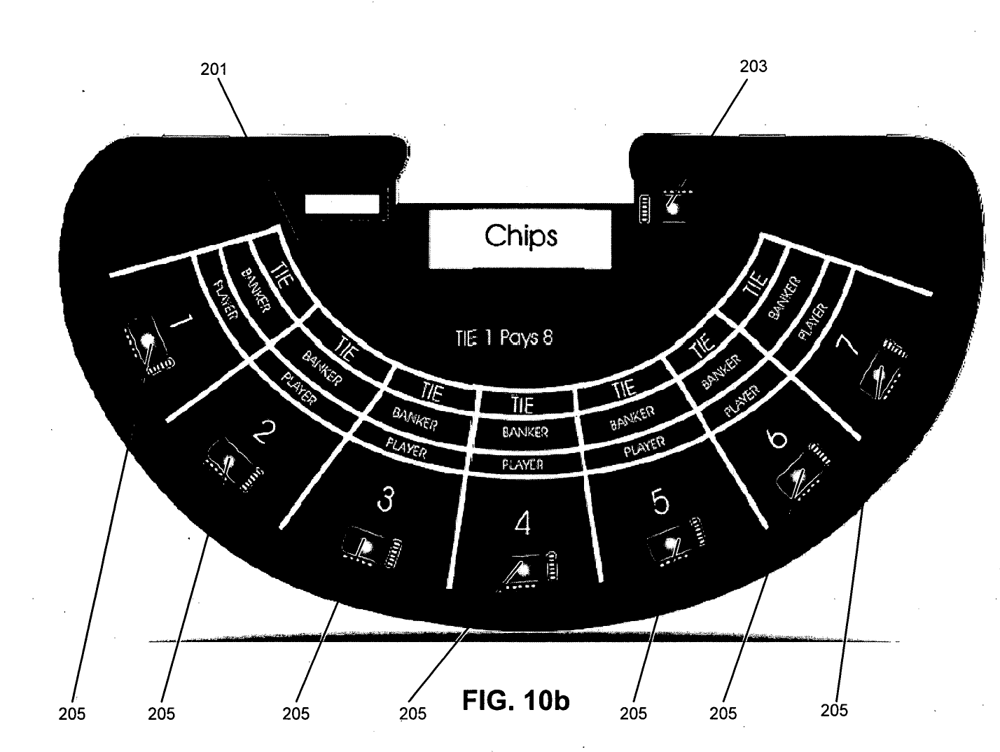

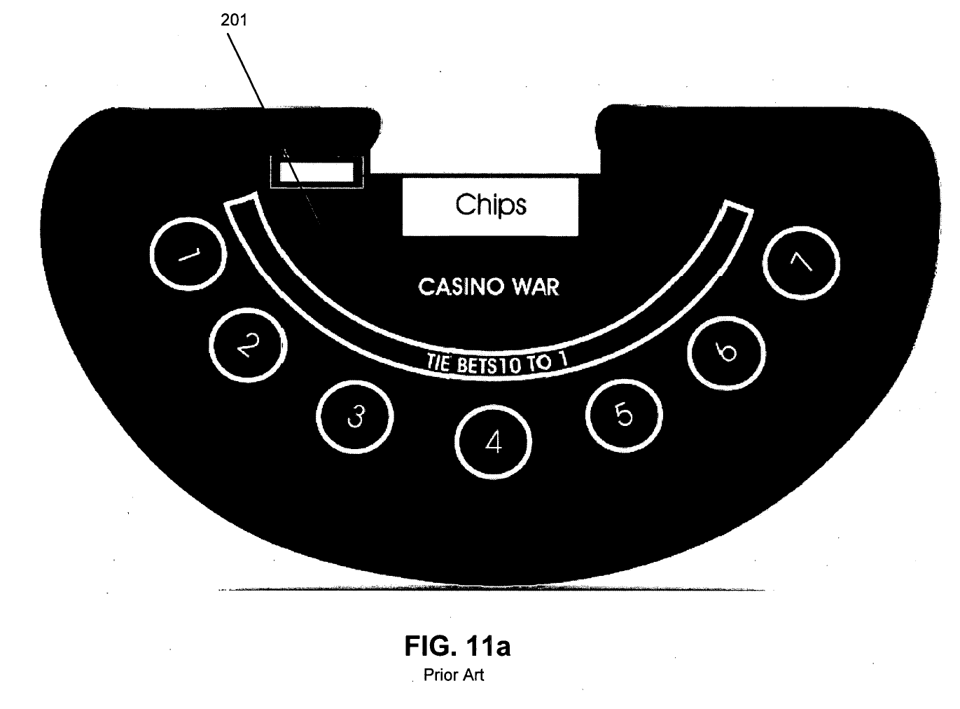

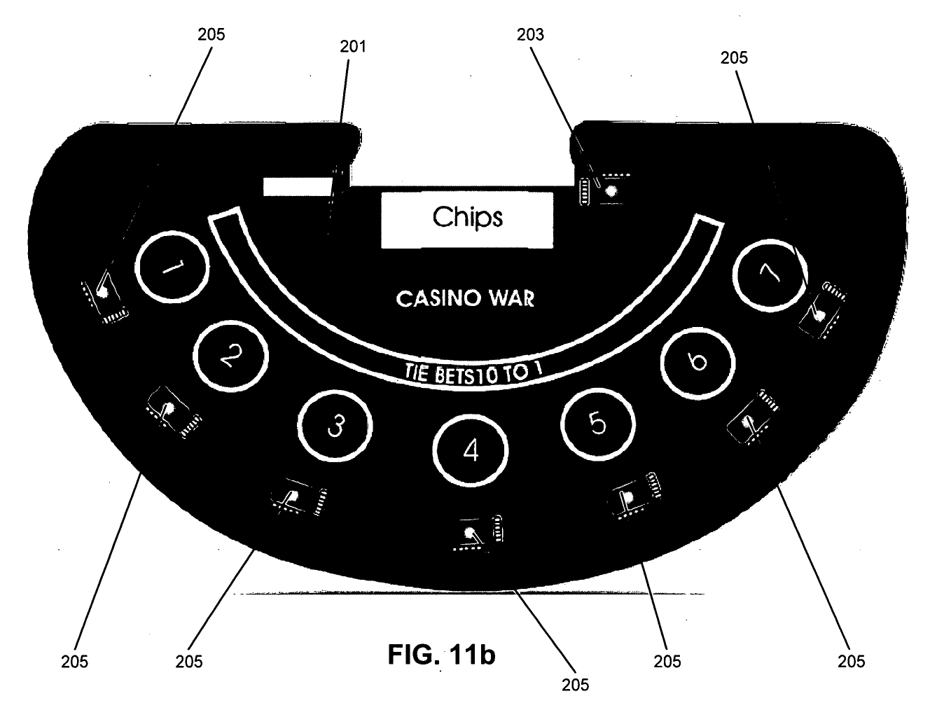

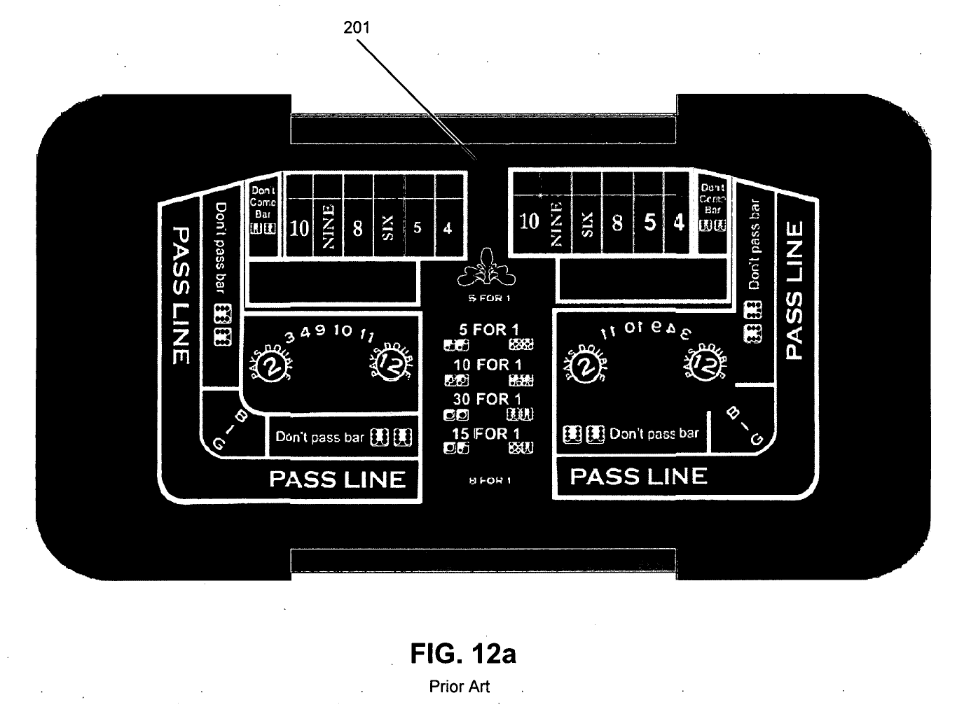

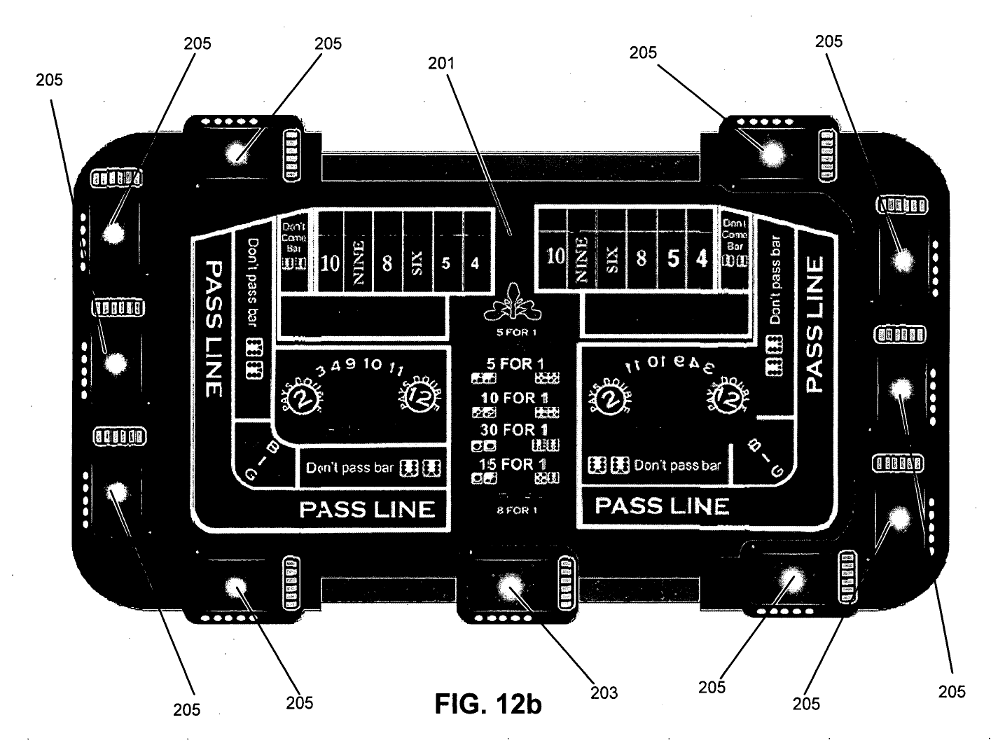

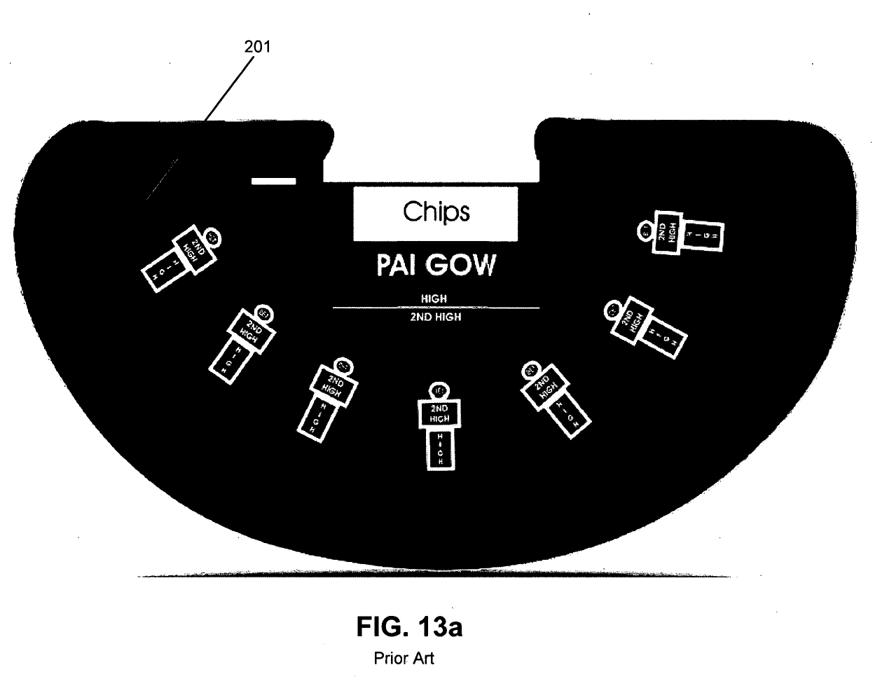

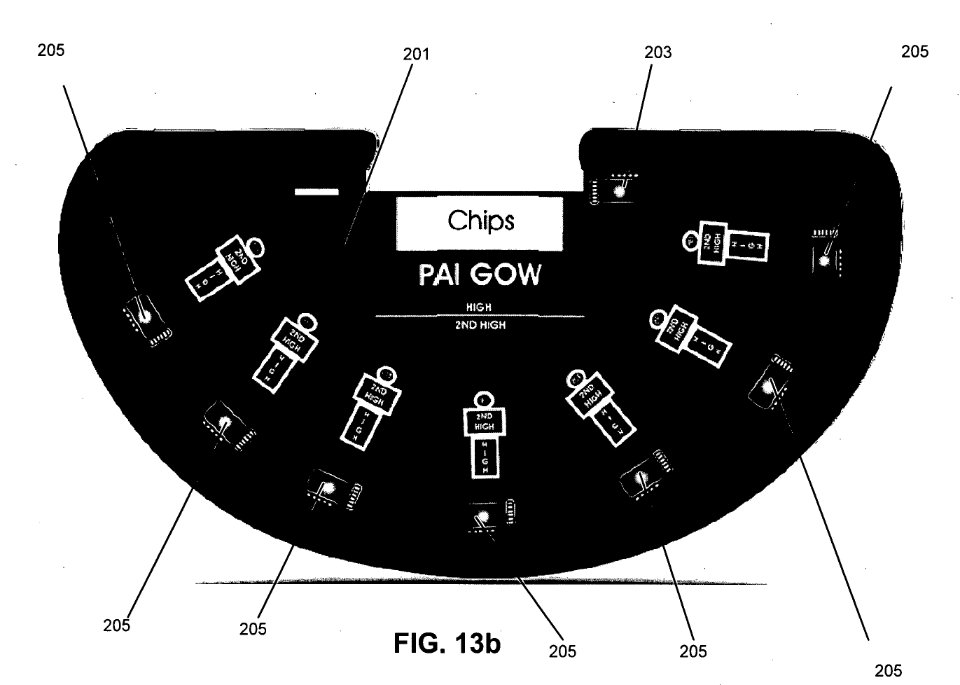

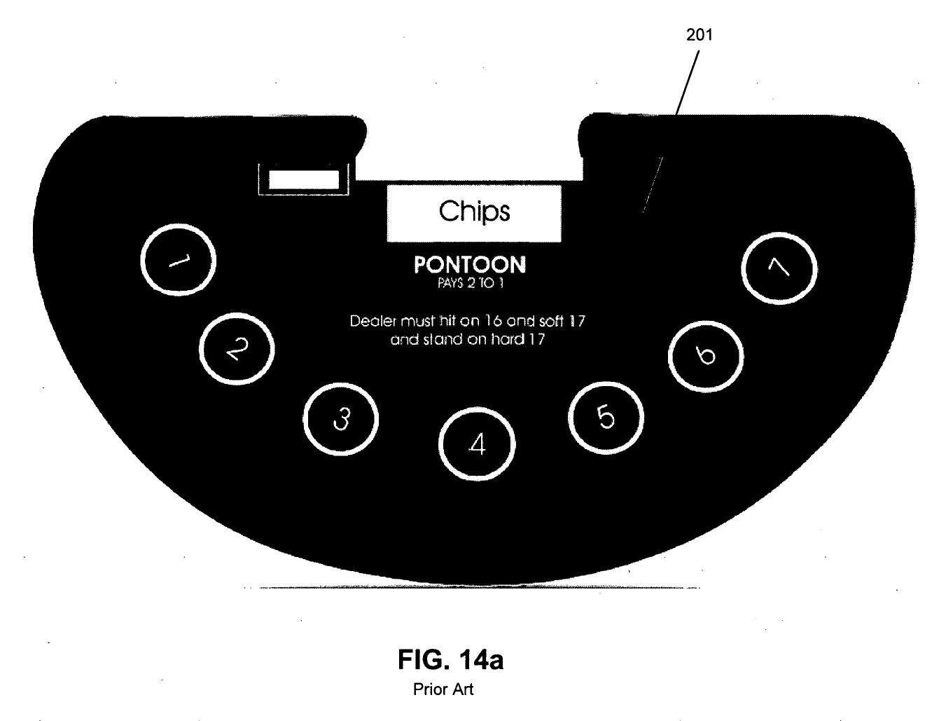

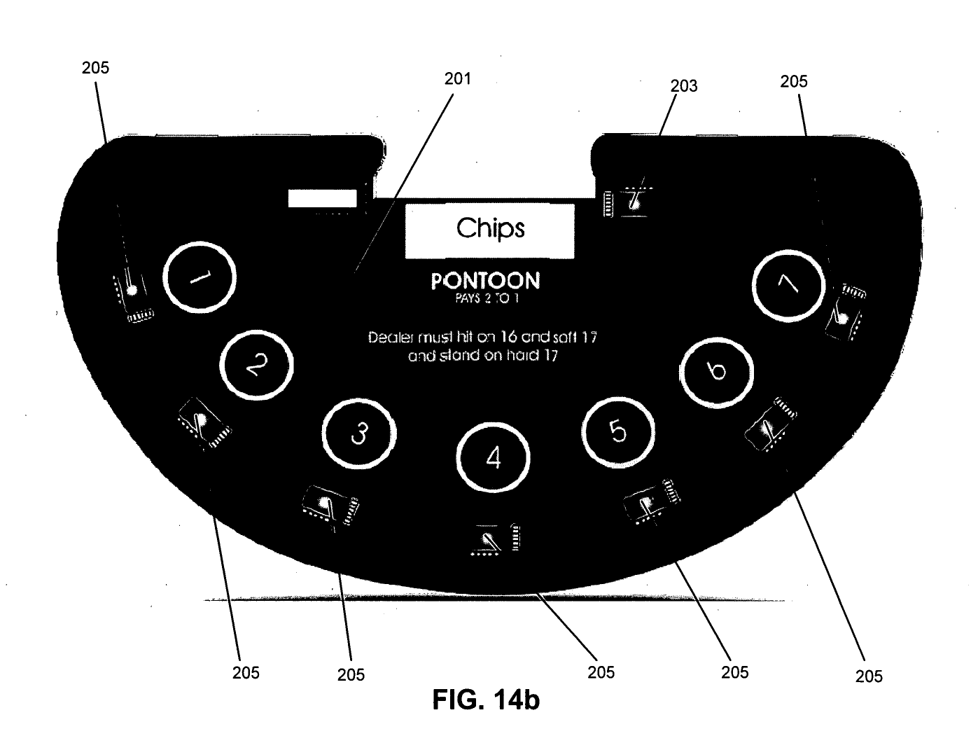

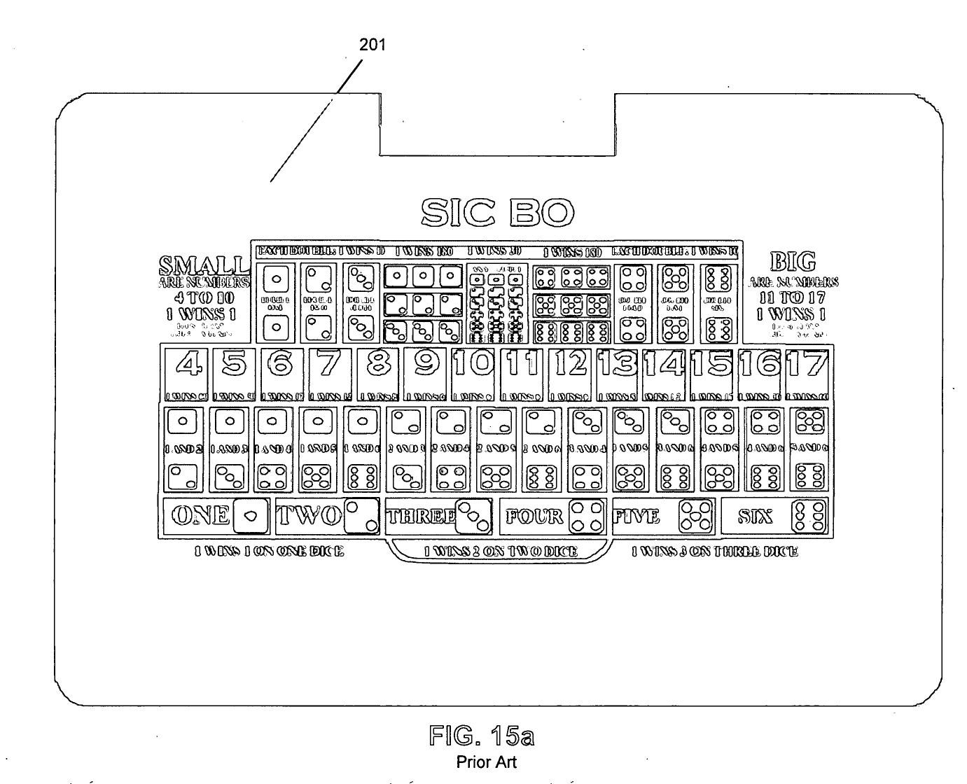

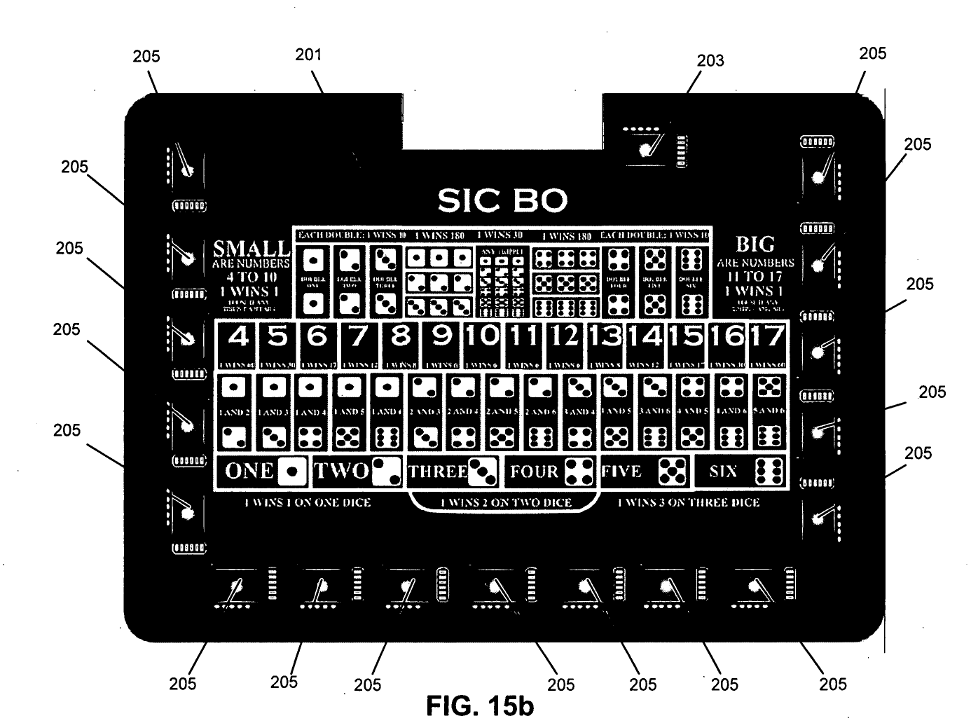

FIG. 5 is a flow chart illustrating a computer assisted method for providing services to a player at a gaming table according to aspects of the disclosure. As seen in step 501, the method may include electronically receiving data from a player device at the gaming table relating to a request for funds for the player operating the player device. Further, as seen in step 503, the method may include electronically receiving data from a computer relating to a financial account associated with the player operating the player device. Further, as seen in step 505, the method may include using a computer to assist in approving or denying the request for funds by making a series of determinations about the electronically received data. As seen in step 507, the method may include determining if the data related to the financial account associated with the player operating the player device indicates that a credit balance of the financial account is greater than the amount of funds requested by the player operating the player device. As seen in step 509, the method may include electronically transmitting an approval or denial of the request for funds to the player device and a dealer device at the gaming table.

According to other aspects of the disclosure, the central computer 211 may be configured to approve a request or deny a request. For example, according to aspects of the disclosure, central computer 211 may access the player's credit balance from the financial accounts database 217 and determine if the credit balance covers the amount of requested funds. If so, the central computer 211 may approve the request. Further, if the player's credit balance does not cover the amount of requested funds, then the central computer 211 may access the player's profile from the player profile database 215 and determine if there is any notation that the player should receive special treatment (e.g., a VIP or high roller status). Depending on the player profile, the central computer 211 may approve or deny the request and forward such approval or denial to the dealer device 203 and pit manager device 207, such as is described above. It is noted that configuring the central computer 211 to determine the approval or disapproval of the request may be advantageous because it requires less attention from the pit manager.

Regardless of whether it is the pit manager or the central computer 211 which approves the request for funds, the player may receive her chips relatively quickly. It is noted that a current practice in casinos is for an individual VIP player to be attended by marketing personnel or guest relations officers. However, service is often slow and time consuming as the service staff lacks authority to do or allow certain transactions, such as potentially those described above. Hence, VIP players may become unhappy with a delay in extending chips at the table. Further, such a delay, may prevent the VIP player from making a large wager that the VIP player may have won if they had chips earlier may further aggravate the VIP player and cause them to leave the casino for a competing casino. Hence, according to aspects of the disclosure, the player may receive her chips more quickly and efficiently and, hence, customer service is increased.

According to aspects of the disclosure, a player's chip count at the gaming table 201 may be periodically updated in the central computer 211, the financial accounts database 217 and/or the PTS. For example, according to aspects of the disclosure, the player, via the player device 205, the dealer, via the dealer device 203, or the pit manager, via the pit manager device 207, may transmit information regarding the player's current chip count to the central computer 211 or the financial accounts database 217. This update of the current chip status of the players at the gaming table 201 may occur periodically, such as after each hand, after a predetermined time (e.g., every 15 or 30 minutes), or randomly at a time of the player, dealer or pit manager's choosing.

Alternatively, the player, via the player device 205, the dealer, via the dealer device 203, or the pit manager, via the pit manager device 207, may update information regarding the player's current chip count locally at their respective machines. According to aspects of the disclosure, the central computer 211 may automatically monitor the player's current status by accessing the player device 205, the dealer device 203, or the pit manager device 207 for such information. In this way, the system 200 may monitor chip status without the player, dealer or pit manager having to affirmatively transmit the information via their respective devices. Of course, if desired, the player, dealer or pit manager may also affirmatively transmit the information from their respective devices in addition to the central computer 211 automatically monitoring the devices. Similarly, according to aspects of the disclosure, the PTS may automatically monitor the player's current status by accessing the player device 205, the dealer device 203, or the pit manager device 207 for such information.

According to other aspects of the disclosure, when the player is finished playing at the gaming table 201, the dealer may update the player's financial account with the amount of funds that the player has remaining in chips. In other words, the player may turn in his chips to the dealer and the corresponding amount of money may be credited to the player's financial account. According to aspects of the disclosure, the dealer may determine the corresponding amount of money and then use the dealer device 203 to transmit a request for approval to the pit manager device 207 regarding the amount of the funds to be transferred into player's financial account. The pit manager may use the pit manager device 207 to approve or disapprove the request. If the request is approved, then either the dealer or the pit manager may process the transaction and forward the transaction information to the central computer 211 and the financial accounts database 217. In this way, the player's account is updated correctly.

It is noted that the above aspects of the disclosure provide the opportunity for the player to engage in play at a gaming table 211 without having to bring or leave with chips. This “chipless” play may be convenient for the player as they player will not have to carry around chips once they leave the gaming table 201. Further, the player will not have to conduct a separate transaction at casino counter, “cage” wherein the casino provides the ability for the player to exchange their chips for money. Hence, aspects of the disclosure increase convenience for the player. Further, is it noted that the “chipless” play may be advantageous for the casino as well. For example, with less chips being transferred by the players between tables, the possibility of counterfeit chips being introduced into the casino is reduced.

Further, the “chipless” play also provides the opportunity for players to place bets on more than one gaming table simultaneously. For example, a player who has accessed a financial account via a player device 205 at a gaming table 201 may request that funds from the account be used to place a wager on a different, remote gaming table. For example, according to aspects of the disclosure, a player sitting at gaming table (e.g., table 1) and may use the player device at table 1 to place a wager on a different, remote gaming (e.g., table 5) without physically moving to table 5. As will be described below, the system 200 allows the pit manager to attend immediately to place a bet at the remote table(s). It is noted, that according to aspects of the disclosure, the player who wishes to place a bet at a remote table does not have to have accessed a financial account via a player device 203 at a gaming table in order to place a wager on a different, remote gaming table. Instead, the player may have merely logged into the player device 203 at a current gaming table and updated the player device 205 with current amount of chips the player has current gaming table. Therefore, the player may use funds from that chip total as the funds for the wager instead of funds from a financial account.

Regardless of the source of the funding, according to aspects of the disclosure, a player may use the player device 205 to request an amount of money (either from the player's current chips or to be withdrawn from the player's financial account) be used to make a wager at a gaming table different from the gaming table at which the player is currently located (e.g., the gaming table wherein the player is logged into the player device 205). According to aspects of the disclosure, the player's request to place a wager on a different gaming table may be transmitted to the pit manager device 207 and, if desired, the dealer device 203 at the corresponding gaming table 201. According to aspects of the disclosure, when the request to place a wager on a different gaming table is sent to the pit manager device 207 (and, if desired, the respective dealer device 203), information regarding the player's chip status at the gaming table at which the player is located and/or the player's updated financial account status may be automatically generated and forwarded to the pit manager device 207 (and, if desired, the respective dealer device 203) along with the request to place a wager on a different gaming table. According to aspects of the disclosure, the automatically generated information regarding the player's financial account with the casino may include the player's current chip status at the current gaming table and/or credit balance in a financial account.

The pit manager may examine the request to place a wager on a different gaming table and the automatically generated information regarding the player's current chip status and or financial account status in order to determine if the request is viable. For example, the pit manager may determine if the financial account associated with the customer has a credit balance large enough to cover the requested amount or the player's current chip status is large enough to cover the request amount. If the credit balance or chip status is large enough to cover the requested amount, the pit manager may approve such a request to place a wager on a different gaming table.

It is noted that according to other aspects of the disclosure, the information regarding the player's chip status or financial account status might not be automatically forwarded to the pit manager's device 203 with the request for funds. In such cases, the pit manager device is configured to access the financial accounts database 217, the central computer 211, the player device 205 or dealer device 203 and retrieve relevant information in order to make a determination.

Additionally, as described above, according to aspects of the disclosure, the pit manager device may be configured to access the customer profile database 215 to determine if the customer profile associated with the customer has information which would be relevant to the player's request.

If the player's request to place a wager on a different gaming table is honored, then the request to place a wager on a different gaming table is processed by the central computer 211 and information regarding the approval and disbursement of wager at the different gaming table is stored. For example, the amount of funds wagered by the player at the different gaming table may be stored either at the central computer 211 and/or in the financial account database 217.

According to aspects of the disclosure, the approval or disapproval of the player's request to place a wager on a different gaming table may be communicated from the pit boss device 207 to the players device 205 and to the dealer's device 203 at the different gaming table and the respective dealer may then take appropriate action (e.g., provide a requested amount of chips for the wager). It is noted that in order to process the transaction, the dealer device 203 may be configured to allow the dealer to transmit information to the central computer 211 verifying that the wager was placed corresponding to the approved amount. According to aspects of the disclosure, the confirmation of the disbursement of the wagered funds may also be communicated to the pit manager's device 203.

It is noted that according to aspects of disclosure, any winnings from a table different from the table at which the player is currently located may be transferred to the player's financial account or, alternatively, presented to the player in chips at the player's current gaming table 201. For example, the second gaming table's dealer device 203 may be configured to transmit the amount of funds won and due to the player to the dealer device 203 on the gaming table at the player's current location, the pit boss device 207 and the central computer 211. According to aspects of the disclosure, the pit boss device 207 may be configured to provide the pit boss with an opportunity to review and approve the disbursement of the winnings to the player.

It is noted that aspects of the disclosure, which allow a player to place wagers on multiple tables via the player device 203 into which player is logged on at the current gaming table 201, is advantageous for the casino and the player. For example, the player may appreciate the ability to place wagers at multiple tables. Further, it increases the volume of gaming at the casino and hence, increases the casino's opportunity to profit. Also, instead of requiring a manual review of wagers placed on different tables prior to authorizing the wager, such a review and authorization may be performed automatically by the casino computer system based on rules and/or heuristics similar to those used in a manual decision making process.

According to aspects of the disclosure, the system 200 may provide receipts regarding the transactions. For example, according to aspects of the disclosure, a player device 205 or a dealer device 203 may be configured with printers that can provide paper receipts. Additionally, the receipts may be electronically communicated to the player (e.g., the central computer 211 may be configured to provide (e.g., automatically provide) an email to a customer's email account regarding any transaction associated with the customer financial account).

According to aspects of the disclosure, a pit manager may have access to every player's information via the pit manager device 207 once the player logs into the player device 205 at the gaming table 201. Similarly, the central computer 211 may have access to every player's information via the pit manager device once the player logs into the player device 205 at the gaming table 201. It is noted that by configuring the system 200 to provide such monitoring and oversight, cheating, fraud or organized gambling attempting to take undue advantage of the casino may be deterred. For example, the monitoring features of the system 200 may aid in preventing players who are given credit facilities from abusing the gaming credit (e.g., by giving chips to 3rd parties for play or encashment without proper approval). Further, the monitoring features of the system 200 may aid in preventing players who are on “rebate” programs from exaggerating their losses to claim more rebates by hiding or concealing chips. Hence, it is understood that the system's monitoring and oversight features may be beneficial for the casino.

According to aspects of the disclosure, a dealer may have access to the information of every player at the table via the dealer device 203 once the player logs into the player device 205 at the gaming table 201. Similarly, the central computer 211 may have access to every player's information via the dealer device 203 once the player logs into the player device 205 at the gaming table 201. It is noted that by configuring the system 200 to provide such monitoring and oversight, cheating, fraud or organized gambling attempting to take undue advantage of the casino may be deterred. For example, the monitoring features of the system 200 may aid in preventing players who are given credit facilities from abusing the gaming credit (e.g., by giving chips to 3rd parties for play or encashment without proper approval). Further, the monitoring features of the system 200 may aid in preventing players who are on “rebate” programs from exaggerating their losses to claim more rebates by hiding or concealing chips. Hence, it is understood that the system's monitoring and oversight features may be beneficial for the casino.

According to aspects of the disclosure, the player device 205 may be configured to provide a communication means between different players. For example, according to aspects of the disclosure, the player device 205 may be configured to send data to, and receive data from, other player devices 205. For example, the data may be transmitted wirelessly or through a hardwired configuration. Therefore, according to aspects of the disclosure, the player device 205 allows the player to send messages, or other data, to another player who is operating on a different player device 205 either at the same gaming table 201 or a different gaming table 201.

This feature may be advantageous to players as it will allow them to communicate without leaving the gaming table 201. For example, it is noted that in virtually all casinos, players are not allowed to play while they are using a mobile device such as a cellular telephone or the like. However, the player device 205 which allows players to communicate with each other without leaving the table will increase a customer's satisfaction with the casino by increasing the player's convenience. Further, the same feature of the player device 205 is also advantageous for the casino, as it will also reduce the interruptions of the player's time at the gaming table 201 and, thereby, potentially increase profitability for the casino. Cheating may be restricted and/or discouraged, e.g., by limiting the types of communication that can be sent between players based on the type of game, player locations, physical proximity, etc.

As mentioned above, according to aspects of the disclosure, a player may customize their own personal settings on an account which is accessed through the player device 205. For example, one of the personal settings may allow the player to choose whether or not the player's status (e.g., whether the player is currently logged in to a player device 205 and playing in the casino), the player's location (e.g., the table number, the seat number), etc. is available to other players that are currently logged into a player device 205. Further, the player may customize his or her own personal settings on an account which may define only a predetermined group of players to be able to see that the player is currently playing and, further, provide his location. For example, a player may have predefined five friends who may see the player's status and location upon the other friends logging into a player device 205. Further, it is noted that according to aspects of the disclosure, in addition to providing the players status and location, the player device may be configured to display a way to communicate with the other players. For example, according to aspects of the disclosure, in addition to a player's status and location being displayed, the player device 205 may also provide a hyperlink or other “one click” methods (e.g., clicking on the player's name) which will provide a method for communicating with the player. For example, upon clicking on the hyperlink a screen to type a message may appear and upon completing the message the player may forward it to the other player at their player device 205. Further, it is noted that the player device 205 may be configured with a means for creating and transmitting voice messages as well.

As discussed above, according to aspects of the disclosure, the player device 205 may be configured to provide a communication means between a player and the casino. For example, according to aspects of the disclosure, the player device 205 may be configured to send data to, and receive data from, other elements in the system 200 such as the central computer 211, pit manager device 207 and dealer device 207. Of course, the above described system 200 will, therefore, provide the casino with an opportunity to communicate directly and privately with the players. For example, pit manager may communicate with the player via the devices 205 and 207 to inform or confirm the player's requests without having the need to disrupt the player's play.

Further, the casino can utilize the system 200 to have direct and yet private communications with individual players. For example, a pit manager or a user of the central computer 211 may utilize the system 200 to send a message to the player device 205. For example, communications such as “Your play is being monitored for money laundering activities; good luck and have a good day” or other messages, such as special promotions may be forwarded to the player via the player device 205.

Further, as noted above, while the player device 205 may be configured to provide a communication means between the player and elements of the casino such as the pit manager device 207 or dealer device 203, according to aspects of the disclosure, the player device 205 may also be configured to communicate with other elements of the casino as well. For example, the player device 205 may be configured to communicate with a bar, restaurant, concierge, front desk, housekeeping, etc within the casino. Hence, for example, the player may order drinks to the gaming table 201 without have to wait for a server to stop by the gaming table 201 and without the player having to leave the gaming table 201. Similarly, without leaving the gaming table, the player may be able to make (or modify) a reservation at restaurant for a time when he expects to arrive.

According to aspects of the disclosure, the player device 205 may be configured to provide the player with an electronic notebook in which the player may make notes regarding a variety of topics and then, if desired, save the notes in account associated with the player (e.g. the player profile). In other words, the player device 205 enables the player to have his own personal notebook to remind himself of various items and to keep track of various things, ranging from personal matters, such as loans made to friends over the gaming tables 201 or chips given to 3rd parties, etc. to other gaming matters, such as notes relating to other player's habits, betting, rolling amounts, wins and losses, amounts won or lost, etc. It is noted that most casinos provide paper and writing materials for players to make notes and record charts. However, this is wasteful as the writing materials are usually discarded after the game. Hence, this feature of the player device 200 is advantageous for the casino as it reduces the cost associated with providing such supplies, and is more environmentally considerate. Further, this feature of the player device 205 is also advantageous for the player as is provides a convenient method for recording such thoughts and, also, storing them in a more permanent and easily retrievable medium.

According to aspects of the disclosure, the player device 205 may be configured to provide the player with one or more score charts of a history of play in various games at the casino (e.g., Baccarat, Roulette, Sic Bo and other similar games). For example, with regard to Roulette, a score chart may list the numbers which “hit” (i.e., the winning numbers) over a past predetermined amount of time (e.g., an hour). Further, the player device 205 may be configured to provide other reference material for the player's benefit. The score charts or other reference materials may assist the player in determining when and how much to wager on various games. For example, a player may devise a formula to maximize their wagers by looking at past gaming history in the form of charts or other reference materials to determine a particular resultant pattern on which to place their next wager.

Therefore, according to aspects of the disclosure, the player may use the player device 205 to access such score charts or other reference material. For example, according to aspects of the disclosure, the player device 205 may be configured to allow player to either download or upload such score charts and reference materials. For example, the player device 205 may be configured to allow the player to import or download the casino's score charts onto the player device 205 from a central computer 211 which stores such information. It is noted that, if desired, such information may be stored in a database with which the central computer 211 may communicate. Further, the player device 205 may be configured to update the score charts or other reference material in real time.

Further, according to aspects of the disclosure, the player device 205 may be configured to allow the player to create their own reference materials or modified score charts based of the original materials provided by the casino through the player device 205. For example, according to aspects of the disclosure, the player may annotate or make notes on a copy of the score chart downloaded or imported to the player device 205. For example, the player device 205 may be configured with a writing feature, wherein the player may use a writing element, such as a stylus, in order to make notes on the copy of the score chart. Further, according to aspects of the disclosure, the player may use buttons or other features on the player device to make notations on the copy of the score chart. It is noted that, if desired, the player may use the player device 205 to save the updated or personalized score charts or other reference material to an account associated with the player.

According to aspects of the disclosure, the player device 205 may be configured to alert the player to particular situations. For example, the player may configure the player device 205 to alert the player with a visible or audible signal if the player has lost a predetermined amount of funds. If the player device 205 determines that situation has occurred, the player device 205 may create the visible or audible signal. Of course, such an alert feature could be used for a variety of situations, including merely reminding the player of a certain time or reservation.

According to aspects of the disclosure, the dealer device 203, the player device 205, the pit manager device 207, etc., may be configured to operate as a personal calculating device. For example, according to aspects of the disclosure, the player may uses a calculator feature of the player device 205 in order to check the accuracy of payouts received from a wining wager.

For example, often various factors may affect the payout of a winning wager. For example, depending on the particular casino game or various other factors, tie bets may result in a ratio of 8 to 1, pair bets may result in a ratio of 11 to 1, super 6 bets may result in a ratio of 12 to 1, etc. Dealers may attempt to determine how much to pay based on these factors and the amount of the wager. Conventionally, dealers may attempt to calculate these payouts mentally. However, such calculations may be difficult to perform mentally. Further, such calculations may be time consuming and, additionally, players may very often wonder whether they were paid correctly and such doubts can negate the joy of winning for the player.

Further, because dealers may attempt to pay, winnings based on such mental calculations, it is possible that the dealers may make a mistake and, if so, the transaction may end up involving a pit manager and surveillance to check for accuracy. This may result in a waste of time and resources. According to aspects of the disclosure, the player device 205 may be configured to perform such calculations. According to aspects of the disclosure, the dealer device 203 may also be configured to perform such calculations. Such features of the player device 205 and dealer device 203 may serve to ease the mind of the players (and dealers) and, further, reduce the use of need for resources such as surveillance, security or manager involvement, etc. to check accuracy of payouts. Hence, time and resources are conserved.

According to aspects of the disclosure, the player device 205 may be configured to provide a communication means between the player and networks outside the casino. For example, according to aspects of the disclosure, the player device 205 may be configured to allow the player to access the Internet.

It is noted that, as described above, in virtually all casinos, a player at the gaming table is not permitted to use a cellular phone or other mobile device. Hence, in order to perform various errands, the player must leave the gaming table 201. As discussed above, this time away from the gaming table may reduce gaming volume, and, thereby, potentially reduce profitability for the casino.

Therefore, according to aspects of the disclosure, the player device 203 may be configured to provide the player with access to outside networks (e.g., the Internet) so that the player will not have to leave the gaming table 201 to attend to such errands. This is advantageous for the player, as the player may appreciate the ability to transmit service commands and instructions to relevant parties to perform errands without him having to leave the casino or gaming tables. Further, is advantageous for the casino as well, because it may increase the time the player is at the gaming table and, hence, potentially increase profitability.

For example, according to aspects of the disclosure, the player device 205 may allow the player arrange airline reservations, transfer funds from a bank (e.g., to his account with the casino), make reservations outside of the casino, etc. without the leaving the gaming table 201 during the course of his play. According to aspects of the disclosure, the player may have unrestricted access to the Internet or limited access (e.g., access to only a select number of websites).

According to aspects of the disclosure, the player device 205 and the system 200 may be configured to provide information to update a player's profile. For example, as described above, a player may originate a profile upon registering with the casino (e.g., when making a reservation or during checking into a hotel associated with the casino). Such information in the player profile may include the player's name, address, telephone number, email address, age, reservation information (length of stay, room number, etc.), etc. Further, additional information about the player, such as the type of financial relationship/account the player has with the casino (e.g., VIP), term of the relationship (e.g., the time customer has been with the casino, etc.) may be determined from the player or casino management and used to expand the player's profile.

Further, as discussed above, according to aspects of the disclosure, once the player logs into the player device 205 at the gaming table 201. Therefore, a dealer may have access to the player profile information of every player at the table via the dealer device 203. Hence, the dealers may be able perform a variety of functions which allow the dealers to provide improved customer service to the player while at a gaming table 201.

For example, if the player profile indicates that the player is VIP, the dealer may be able to alert a pit manager or other parts of the system in order to provide additional customer service or perks to the player. Further, the player profile may contain information on the player's gaming history. This information may include notes or other comments, codes, etc., regarding the player that have been inserted into the player profile by the casino. For example, if the player has a history of high bets, behavior issues, or if the player has particular likes or dislikes (e.g., whether the player likes to talk with the dealer, or whether the player prefers not to talk very much with the dealer, etc.), notes of comments relating to such player history may be included in the player profile (these comments or notes may not be visible to the player, if desired) and displayed on the dealer device 203 so the dealer may take appropriate action (observe the player more closely, contact a pit manager, “chat the player up” or refrain from talking to the player, etc. to make the player feel for conformable, etc.).

Additionally, the dealer device 203 may be configured to with a multitude of features that assist the dealer in performing their tasks. For example, it is noted that the dealer device 203 may be configured to have the same construction and the same features as player device 205. For example, the dealer device 203 may be configured to provide the dealer a personal calculating device (such as described above) which allows the dealer to quickly and reliably determining a player's payout for a winning wager. Further, the dealer device 203 may be configured to provide the dealer with a communications means to transmit information to, or receive information from, a pit manager, other dealers, waitress, restaurants, other parts of the system 200, etc., in order to enhance customer experience. For example, the dealer may use the dealer device 203 in order to call a waitress to take a customer's drink order. Further, because the dealer device 203 may have access to the player profile which may include information about the player (e.g., the type of drink the player usually prefers) such information may be utilized to automatically customize the player's drink order. Further, the dealer may use the dealer device 203 make a reservation at a restaurant for the player. Again, because the dealer device 203 may have access to the player profile, such information (e.g., favorite restaurants frequented, time the player usually has dinner, etc.) may be used to automatically make the reservation or assist the dealer in making the reservation. Further, the dealer may be able to use the dealer device 203 to summon the pit manager quickly for a customer request.

Additionally, similarly to the player device 205 discussed above, the dealer device 203 may be customizable such that the dealer device 203 is configured to a particular dealer's liking upon the dealer logging in or authenticating themselves through the dealer device 203. Any, some, or all other features described herein with regard to the player device 205 may also be included in the dealer device 203 if desired. In this way, casinos may provide dealers with support and assistance in their responsibilities as a dealer and, also, provide dealers with support and assistance to enhance customer service for the player at the gaming table 201. Additionally, it is noted that the pit manager device 207 may also be configured with the features described herein with regard to the dealer device 203 and the player device 205.

Additionally, according to aspects of the disclosure, the player device 205 and the system 200 may be configured to monitor and record various aspects of the player's time at the gaming table in order to expand the players profile and create a more accurate profile of the player. For example, according to aspects of the disclosure, any information transmitted through the player device 205 or other parts the system 200 may be recorded and analyzed in order to create a more accurate profile of the player. As will be described in detail below, according to aspects of the disclosure, the information in the player profile may be utilized by the casino for various purposes including enhancing customer service for the player, player monitoring, etc.

Similarly, according to aspects of the disclosure, the PTS may be configured to monitor and record various aspects of the player's time at the gaming table. For example, as discussed above, the system 200 may include (or transmit data to and receive data from) a PTS. Therefore, according to aspects of the disclosure, any information transmitted through the player device 205 or other parts the system 200 may be transmitted to, recorded and analyzed by the PTS. In this way, the PTS may ascertain information about the player's experience at the gaming table(s), such as which games a player is playing, how long the player has been playing, how much the player is usually wagering, whether the customer has won or lost money, how much money the player has won or lost, etc. Based on this information received by the PTS from the player device 205 (or other parts of the system, e.g., the dealer device 203, pit manager device 207, etc.), the PTS can provide the player with “comps” or other rewards. For example, “comps” may be awarded based on the amount of money wagered by the player. Further, “comps” may be awarded based on a theoretical win for the casino (or loss for the player). Therefore, such calculations may be computed by the PTS based on the information received from the system 200 (e.g., the player device 205) and, thereupon, the player may be awarded with “comps” according to the calculations. It is noted that, according to some aspects of the disclosure, the PTS may award points which the customer may accumulate through playing at the gaming tables and when the player accumulates a predetermined amount of points they receive a “comp”. According to aspects of the disclosure, the points, “comps”, etc. may be stored in the PTS or another part of the system 200.

It is noted that this information may be transmitted to the PTS automatically (e.g., periodically or instantaneously) by the player device 205 (or other parts of the system, e.g., the dealer device 203, pit manager device 207, central computer 211 etc.) or affirmatively by the player, dealer, pit manager, etc., transmitting the data of their own accord through the player device 205 (or other parts of the system, e.g., the dealer device 203, pit manager device 207, etc.). Hence, according to aspects of the disclosure, the calculation of points or “comps” may be done quickly, such as in real time, or near real time, if desired.

Further, according to aspects of the disclosure, the PTS may be configured to alert a representative of the casino in particular instances when certain conditions are satisfied. For example, if the player accumulates a particular amount of points which would justify the player receiving a “comp” the PTS may notify a casino representative (e.g., the PTS may utilize the system 200 to make such a notification) that the customer should receive a “comp”. For example, the PTS may send a message, such as a SMS, email, voicemail, etc. to the casino representative that the customer should receive a “comp”. In this way, the casino representative may provide the customer with the “comp” in a rapid and efficient manner. Hence, customer service is increased and the customer is more likely to remain satisfied with the particular casino.

Further, it is noted that the PTS may utilize the above described information transmitted through the player device 205 (or other parts the system 200) to monitor the players' wagers and provide an accurate count of points, rewards, rebates, “comps”, etc., attributed to the player's experience at the gaming table. Further, according to aspects of the disclosure, if desired, the PTS may display a current and accurate count of the player's points, rewards, rebates, “comps”, etc. For example, the current and accurate count may be displayed on the player device 205 (or other parts of the system, e.g., the dealer device 203, pit manager device 207, etc.).

It is noted that over long periods of time at a gaming table there is the potential for discrepancies between the player and casino regarding the amount of points, rewards, rebates, “comps”, etc., accumulated by the player over the period of time. Therefore, by utilizing the PTS and the system 200 as described above, the casino may limit, or avoid, potential disputes that may occur between the player and casino regarding the amount of points, rewards, rebates, “comps”, etc., accumulated by the player or other aspects of the gaming experience.

It is noted that information calculated by the PTS (such as the information discussed above) may be transmitted to other parts of the system 200, such as the customer profile database 215. Therefore, as will be described in detail below, according to aspects of the disclosure, the customer profile database 215 and the system 200 may utilize the information for various purposes including enhancing customer service for the player, player monitoring, etc.

According to aspects of the disclosure, the player profile data stored in the customer profile database 215 may be updated as desired. For example, new information may be transmitted to, and stored in, the customer profile database 215. For example, once a player authenticates themselves at a player device 205 at a particular gaming table 201, the casino has a unique opportunity to gather relevant information about the player. For example, information such as: which games a player plays, how long the player's sessions are, when the player plays (e.g., what time of day or what days of the week), how much a player usually wagers, whether the customer has won or lost money (e.g., per session, per day, per trip, per entire history), etc. may be obtained from the gaming table sessions. Such information can be determined from the player device 205, dealer device 203, pit manager device 207 and transmitted to, and stored in, the customer profile database 215 or the PTS. For example, in addition to the information from the player device, it is noted that the dealer or pit manager via their respective devices, 203 and 207, may also make notes regarding the player's behavior and forward such information to the player's profile. With the above described information, the casino may expand a customer profile of player who gambles in a casino.

Further, the casino may also determine other information regarding the player based on the player's use for the player device 205. For example, if the player uses the player device 205 to make dinner reservations, request service from the bar or concierge, make flight reservations, etc. such information may be recorded by the casino (e.g., in the customer profile database 215). It is worth noting, that according to aspects of the disclosure, sensitive information such as credit card numbers, bank account numbers, etc. might not be recorded.

Once the information is saved into the player's profile, the player profile may be analyzed and leveraged. For example, if the player frequently makes reservations at a particular restaurant or show or frequently orders a particular drink, such information may be noted and leveraged by the casino. For example, the casino may offer the player comps or discounts at such restaurants or ensure that such drinks are provided to the player in a timely fashion at the gaming table without the player having to request the drink. Similarly, the casino may provide a complimentary bottle of the brand of alcohol in the player's room as a welcome gift the next time the player stays at the casino. Further, if the player routinely travels to the casinos for weekend visits, the casino may offer the player special rates on weekend packages. Therefore, it is understood, that the above described system 200 provides much potential for marketing, customer service, etc. based on the information garnered from the player device 205. Hence, it is understood and any information regarding the player that may be garnered via the player device 205, the dealer device 203 or the pit manager device 207 may be leveraged by the casino in order to build an accurate profile of the player (including their gaming character) and, further, perform various functions (e.g., increased customer service if they are a high roller or VIP, develop marketing campaigns or promotions, etc.).

It is noted that the above described features and aspects of the disclosure may be implemented through a computer environment, such as an online casino or other gaming website. For example, in such a computer environment, the user of the computer could use the Internet to visit a particular website and play a game (such as the games described above) via the computer through the gaming website. According to aspects of the disclosure, in such online casinos or other gaming websites, the gaming table may be depicted graphically on a computer screen associated with the computer device. Further, the player device 205 may also be depicted graphically on the screen (e.g., the player device 205 may be shown on the virtual gaming table). Alternatively, a larger version of the player device 205 may be graphically represented on the player's screen apart from the graphically depicted gaming table. Alternatively, or additionally, the functions of the player device 205 described above may be displayed on the screen as well (e.g., on a drop down menu, or an on-screen menu). The user may user one of the methods to perform one or more of the various functions described above with regard to the player device 205.

It is noted that according to aspects of the disclosure, in the computer environment, the user may authenticate themselves (e.g., through as password or other method) just as a player may have to do in order to use a physical player device 205 at an actual casino (such as described above). Further, according to aspects of the disclosure, the online casino or other gaming website may be configured to allow the user to create a financial account with the online casino or other gaming website in order to access the funds with which to gamble. Additionally, or alternatively, the user may use another method (e.g., provide a credit card number) in order to access the funds with which to gamble.

According to aspects of the disclosure, in the computer environment, the dealer device 203, pit manager device 207, etc. may be virtually represented and/or communicatively connected over the wide-area network (e.g., the Internet). Further, a representative of the online casino or other gaming website may use the virtual dealer device 203, pit manager device 207, etc. to perform the actions associated with the dealer and pit manager described above with regard to an actual, physical dealer device 203, or pit manager device 207. For example, the representative of the online casino or other gaming website could authenticate him or herself and operate in the virtual device in same manner described above in which the user operates the player device 205.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. For example, any of the above described systems and methods or parts thereof may be combined with the other methods and systems or parts thereof described above. For example, the aspect of determining deposit amounts within branches of the second bank may be combined with any of the above described aspect of determining shared customers. It will also be appreciated and understood that modifications may be made without departing from the true spirit and scope of the present disclosure. The description is thus to be regarded as illustrative instead of restrictive on the present disclosure.

1. A gaming table comprising:
a surface upon which elements of a particular casino game may be placed; and
a player device configured to provide one or more services to a player at the gaming table, wherein the player device includes:
a processor;
a display;
a means for providing input to the player device; and
memory storing computer executable instructions that, when executed, cause the player device to perform a method for providing one or more services to the player at the gaming table,
wherein the player device is configured to:
receive input from the player at the gaming table;
transmit data to a remote computer based on the input received from the player at the gaming table; and
electronically receive data regarding the input from the player at the gaming table, wherein the electronically received data is based on the data transmitted to the remote computer,
wherein the input from the player at the gaming table is a request for funds, and
wherein the electronically received data regarding the input from the player at the gaming table is an approval or a denial of the request for funds from player at the gaming table.

2. The gaming table according to claim 1, wherein the computer is positioned at the surface of the gaming table.

3. The gaming table according to claim 1, wherein the gaming table further comprises more than one player device.

4. The gaming table according to claim 3, wherein the gaming table includes a player device at each position of the gaming table configured to seat a player.

5. The gaming table according to claim 1, wherein the remote computer is a pit manager device which includes:
a processor;
a display;
a means for providing input to the pit manager device; and
memory storing computer executable instructions that, when executed, cause the pit manager device to perform a method for providing one or more services to the player at the gaming table,
wherein the pit manager device is configured to retrieve data regarding a financial account associated with the player at the gaming table.

6. The gaming table according to claim 1, wherein the player device is configured to transmit data regarding the actions of the player at the gaming table to a second remote computer.

7. The gaming table according to claim 6, wherein the data regarding the actions of the player at the gaming table includes at least one of: the time the player spent at the gaming table, the amount of funds won or lost by the player at the gaming table, and communications the player at the gaming table made through the player device.

8. The gaming table according to claim 1, further comprising a dealer device configured to provide one or more services to a dealer at the gaming table, wherein the dealer device includes:
a processor;
a display;
a means for providing input to the dealer device; and
memory storing computer executable instructions that, when executed, cause the dealer device to perform a method for providing one or more services to the player at the gaming table,
wherein the dealer device is configured to allow the dealer at the gaming table to perform arithmetic calculations,
wherein the player device is configured to allow the player at the gaming table to perform arithmetic calculations.

9. The gaming table according to claim 1, wherein the player device is configured to retrieve data relating to previous gaming history from a second remote computer which stores previous gaming history, wherein the player device is configured to display the retrieved data relating to the previous gaming history on the display of the player device.

10. The gaming table according to claim 1, wherein the player device is configured to transmit data to, and receive data from, the Intranet.

11. The gaming table according to claim 1, wherein the player device is configured to submit a wager on a game at a second gaming table.

12. A computer assisted method for providing services to a player at a gaming table comprising:
electronically receiving data from a player device at the gaming table relating to a request for funds for the player operating the player device;
electronically receiving data from a computer relating to a financial account associated with the player operating the player device;
using a computer to assist in approving or denying the request for funds by making a series of determinations about the electronically received data, wherein the determinations include:
determining if the data related to the financial account associated with the player operating the player device indicates that a credit balance of the financial account is greater than the amount of funds requested by the player operating the player device;
electronically transmitting an approval or denial of the request for funds to the player device and a dealer device at the gaming table.

13. The computer assisted method of claim 12, further comprising:
electronically receiving data from the computer wherein the data relates to a customer profile associated with the player operating the player device,
wherein the determinations further include:
determining if the data related to the customer profile associated with the player operating the player device indicates that the player operating the player device has a status that justifies the amount of funds requested by the player operating the player device to be approved regardless of the credit balance of the financial account associated with the player operating the player device.

14. A system configured to provide services to a player at a gaming table comprising:
a gaming table including:
a surface upon which elements of a particular game may be placed; and
a player device configured to provide one or more services to a player at the gaming table, wherein the player device includes:
a processor;
a display;
a means for providing input to the player device; and
memory storing computer executable instructions that, when executed, cause the player device to perform a method for providing one or more services to the player at the gaming table; and
a dealer device configured to provide one or more services to a player at the gaming table, wherein the dealer device includes:
a processor;
a display;
a means for providing input to the dealer device; and
memory storing computer executable instructions that, when executed, cause the dealer device to perform a method for providing one or more services to the player at the gaming table;
a pit manager device configured to provide one or more services to a player at the gaming table, wherein the pit manager device includes:
a processor;
a display;
a means for providing input to the pit manager device; and
memory storing computer executable instructions that, when executed, cause the pit manager device to perform a method for providing one or more services to the player at the gaming table; and
a computer configured to electronically receive data from, and transmit data to, each of the player device, dealer device and the pit manager device,
wherein the computer is configured to access a database which includes financial account information for a player at the gaming table,
wherein the computer is configured to access a database which includes player profile information for a player at the gaming table.

15. The system according to claim 14, wherein the player device is configured to:
receive input from the player at the gaming table;
electronically transmit data to the pit manager device based on the input received from the player at the gaming table; and
electronically receive data from the pit manager device regarding the input from the player at the gaming table, wherein the electronically received data is based on the data transmitted to the pit manager device,
wherein the input from the player at the gaming table is a request for funds, and
wherein the electronically received data from the pit manager device regarding the input from the player at the gaming table is an approval or a denial of the request for funds from player at the gaming table.

16. The system according to claim 15, wherein the pit manager device is configured to retrieve from the computer data regarding the financial account of the player at the gaming table.

17. The system according to claim 14, wherein the player device is configured to electronically transmit data regarding the actions of the player at the gaming table to the computer.

18. The system according to claim 17, wherein the data regarding the actions of the player at the gaming table includes at least one of: the time the player spent at the gaming table, the amount won or lost by the player at the gaming table, and communications the player at the gaming table made through the player device.

19. The system according to claim 17, wherein the computer is configured to update a profile associated with player at the gaming table based on electronically transmitted data regarding the actions of the player at the gaming table.

20. The system according to claim 14, wherein at least one of the player device, dealer device and pit manager device is configured to electronically transmit to the computer updates on the financial status of a player at a gaming table at predetermined intervals.
